(19) United States
(12) Patent Application Publication
(10) Pub. No.: US 2002/0052440 A1
(43) Pub. Date: May 2, 2002

(54) Long glass fiber filler reinforced resin material for molding, injection-molded article molded by injecttion-molding the resin material, and method for molding the resin material

(76) Inventors: Takahiro Tochioka, Hiroshima (JP); Kazuhisa To, Hiroshima (JP); Kenji Moriwaki, Hiroshima (JP)

Correspondence Address: NIXON PEABODY, LLP, 8180 GREENSBORO DRIVE, SUITE 800, MCLEAN, VA, 22102, US

(21) Appl. No.: 09/993,766

(22) Filed: Nov. 27, 2001

Related U.S. Application Data
(63) Continuation of application No. PCT/JP01/02027, filed on Mar. 14, 2001.

(30) Foreign Application Priority Data
Mar. 28, 2000 (JP) 2000-088121
Nov. 24, 2000 (JP) 2000-357098
Feb. 20, 2001 (JP) 2001-043444

(51) Int. Cl. C08K 3/40

(52) U.S. Cl. 524/494

(57) ABSTRACT

A long glass fiber filler reinforced resin material for molding includes a matrix polymer comprising a polypropylene component having a pentad isotactic index of at least 95%, and having a melt flow rate (JIS K7210, a temperature of 230 ° C.; and a load of 21.18N) of 100 to 300 g/10 min; a long glass fiber filler in a content of 30 to 50 mass percent with respect to a total mass; an affinity providing component for providing affinity between the matrix polymer and the long glass fiber filler. At least the matrix polymer and the long glass fiber filler form a composite. Thus, breakage of the long glass fiber filler is suppressed during molding processing, so that a molded article having a high bending modulus and a high impact strength can be molded.

This application is a Continuation of International Application No. PCT/JP01/02027, filed Mar. 14, 2001.

### BACKGROUND OF THE INVENTION

The present invention relates to a long glass fiber filler reinforced resin material for molding used in injection molding or the like, an injection-molded article molded by injection-molding the resin material, and a method for molding the resin material.

Long glass fiber reinforced resin materials comprising a composite of a long glass fiber filler of about 10 mm length and a resin are widely used as materials for various industrial articles such as automobile parts, because of their excellent mechanical characteristics and molding processability.

As an example of such long glass fiber filler reinforced resin materials, Japanese Laid-Open Patent Publication No. 7-232324 discloses a material obtained by the following method. A denatured polypropylene resin having a melt flow rate (hereinafter, referred to as “MFR”) of 70 to 300 g/10 min is molten, and glass fiber bundles are impregnated with the molten denatured polypropylene resin. Thereafter, the resultant is cut to a length of 2 to 50 mm into pellets, which are masterbatch, and the masterbatch is diluted with a polypropylene resin. This constitution is directed to improving the dispersibility of the long glass fiber filler in the masterbatch produced by a drawing method, and preventing deterioration of the strength of a molded article due to dilution of the masterbatch with a polypropylene resin.

Furthermore, Japanese Laid-Open Patent Publication No. 3-25340 discloses a blend of a long glass fiber filler reinforced pellet comprising low molecular weight thermoplastic polymer and at least 30 volume percent of glass filaments for reinforcement, and thermoplastic polymer having a higher molecular weight than that of the thermoplastic polymer contained in the pellet. This constitution is directed to improving the wetting property of the resin with respect to the long glass fiber filler and improving the bend modulus of a molded article.

Furthermore, Japanese Laid-Open Patent Publication No. 11-152062 discloses a front end for automobiles produced by injection-molding a raw material comprising thermoplastic resin pellets containing 20 to 80 mm mass percent of glass fibers of a full length of 2 to 100 mm arranged in parallel to each other, using a thermoplastic resin (polypropylene, ethylene-propylene block copolymer, etc.) as the matrix. The content of the glass fibers of the front end is 15 to 50 mass percent, and the weight average fiber length is 1 to 20 mm. This publication describes that this constitution can ensure excellent vibration fatigue properties and impact resistance and can suppress curvature deformation.

Japanese Patent Publication No. 2721702 discloses a composition obtained by blending polypropylene (propylene homopolymer or the like) and a reinforcing material (glass fibers or the like). The polypropylene has a MFR of about 55 to 430 g/10 min, and the reinforcing material is contained in a ratio of about 20 to 65% based on the total mass of the polypropylene and the reinforcing material. This publication describes that with this constitution, the flowing characteristics are better than those of a fiber reinforced composition made of a polymer with a low MFR, and at the same time, deterioration of the characteristics of the composition regarding the strength and the rigidity of a molded article can be prevented.

Japanese Laid-Open Patent Publication No. 6-340784 discloses a propylene based heat resistant resin molding material comprising 3 to 97 mass % of a glass fiber bundle structure and 97 to 3% of a crystalline propylene based polymer (propylene homopolymer, ethylene-propylene copolymer, etc.) having a MFR of 50 g/10 min or more. The glass fiber bundle structure comprises 20 to 80 parts by mass of glass fibers for reinforcement substantially all of which have a length of at least 3 mm and a diameter of 20 μm or less, and 80 to 20 parts by mass of a crystalline propylene based polymer (propylene homopolymer, ethylene-propylene copolymer, etc.) that is at least partially denatured with unsaturated carboxylic acid or the derivatives thereof and has a MFR of 50 g/10 min or more in the entire polymer. In the glass fiber bundle structure, the grass fibers for reinforcement are arranged substantially in parallel to each other in the polymer component. This publication describes that with this constitution, a molded article obtained by injection molding or the like has excellent heat resistance, moldability, and molding curvature resistance, and a small weight, so that the molded article can be applied to automobile parts that should have a small weight, and requires high heat resistance and molding dimension stability. This publication also describes that the impact strength and the molding curvature resistance of the molded article can be improved by adding at least one elastomer selected from ethylene based elastomers (ethylene-propylene rubber (EPM), ethylene-propylene- non-conjugated diene terpolymer rubber (EPDM)) and styrene based elastomers (hydrogenated styrene-butadiene block copolymer, etc.).

Japanese Laid-Open Patent Publication No. 11-228759 describes a propylene based resin composition comprising 90 to 30 mass percent of a propylene based resin (propylene homopolymer, ethylene-propylene block copolymer, etc.) having a MFR of 1 to 1000/10 min., a pentad isotactic index of 95% or more in the propylene homopolymer portion, and an elusion amount of 2.0 mass percent or less at 40° C. or less by chromatograph, 10 to 70 mass percent of elastomer (ethylene-propylene copolymer rubber (EPR), ethylene-propylene-diene copolymer rubber (EPDM), etc.) having a MFR of 0.1 to 100/10 min, and an inorganic filler (glass fiber or the like) in a ratio of 5 to 75 mass percent based on the total mass of the propylene based resin and the elastomer. The publication describes that with this constitution, a molded article molded by injection molding is significantly improved in the scratch resistance and the bending modulus.

Examples of a method for molding a resin into a molded article include press forming and injection molding. When the two methods are compared, it is difficult to mold a complicated shape by press molding, whereas it is easy to mold a complicated shape by injection molding and therefore the degree of freedom is high in injection molding. Furthermore, press forming requires post-processing such as stamping for openings or the like, whereas injection molding does not require such post-processing, and therefore the processability is good in injection molding. Furthermore, press forming requires the process of setting a resin plate (blank) to a mold, heating, and compression, whereas only injection of a molten resin into a mold is required and continuous molding can be performed in injection molding, and therefore the productivity is high in injection molding. Therefore, in view of the above points, injection molding is better than press forming.

However, when the same long glass fiber filler reinforced resin material is used for molding, as shown in FIG. 21, although the article molded by injection molding and the article molded by press forming have the same level of bending modulus, the former has a significantly low impact strength (Izod impact value) than that of the latter. It is known that the bending modulus of the resin molded article depends on the amount of the contained long glass fiber filler, whereas the impact strength depends on the fiber length of the contained long glass fiber filler. The above-described phenomenon implies that the long glass fiber filler is broken and is made short in the process from the introduction of a material to the end of molding in injection molding. In fact, according to the experiment results, in press forming, when a resin material comprising a long glass fiber filler having a fiber length of about a little more than 10 mm is used for molding, the length of a long glass fiber filler extracted from the molded article is about 10 mm. On the other hand, in injection molding, when a resin material comprising a long glass fiber filler having a fiber length of about 10 mm is used for molding, the length of a long glass fiber filler extracted from the molded article is about 0.9 mm. As shown in FIGS. 22A and 22B, the long glass fiber filler seems to be broken in the following manner. A solid phase 7 and a molten phase 8 of a resin are formed in a cylinder of an injection molding machine, and the long glass fiber filler is bended by shearing between the resin phases at the interface between the solid phase 7 and the molten phase 8, and thus is broken. Alternatively, the long glass fiber filler seems to be broken because the long glass fiber filler is bended by buckling during shear flow of the resin in the molten phase 8.

The above-described problems have been tackled by improving the dispersibility and the adhesive properties of the long glass fiber filler as described in Japanese Laid-Open Patent Publication No. 7-232324 to improve the impact strength. However, as shown in FIG. 23, this level is not yet comparable to that of the article formed by press forming. The impact strength can be improved further by adding polypropylene elastomer or polyethylene elastomer. However, as shown in FIG. 23, such an approach deteriorates the bending modulus.

### SUMMARY OF THE INVENTION

In view of the above-mentioned conventional problems, the present invention has an object of providing a long glass fiber filler reinforced resin material for molding that can suppress breakage of the long glass fiber filler in molding processing, and can provide a molded article having a high bending modulus and a high impact strength, an injection-molded article molded by injection-molding the resin material, and a method for molding the resin material.

The present invention for achieving the above objects makes it possible to produce a molded article having a high bending modulus and a high impact strength by using a polymer comprising a polypropylene component having a high pentad isotactic index so as to raise the crystallinity and having a low melt viscosity as the matrix polymer of a long glass fiber filler reinforced resin material for molding. Furthermore, another aspect of the present invention makes it possible to produce a molded article having a high bending modulus and a high impact strength by mixing a diluent polymer having a relatively high viscosity with a masterbatch that is a composite of a matrix polymer having a relatively low viscosity and a long glass fiber filler so as to constitute a long glass fiber filler reinforced resin material so that the long glass fiber filler is coated and protected with the matrix polymer, thereby suppressing breakage of the long glass fiber filler and achieving high strength in the resin portion by mixing the diluent polymer.

More specifically, the present invention provides a long glass fiber filler reinforced resin material for molding comprising: a matrix polymer comprising a polypropylene component having a pentad isotactic index of at least 95%, and having a melt flow rate (JIS K7210, a temperature of 230° C.; and a load of 21.18N) of 100 to 300 g/10 min; a long glass fiber filler in content of 30 to 50 mass percent with respect to the total mass; an affinity providing component for providing affinity between the matrix polymer and the long glass fiber filler. At least the matrix polymer and the long glass fiber filler form a composite.

According to the above embodiment, the MFR of the matrix polymer is in appropriately high level (the molecular weight is low). Therefore, for example, the overall melt viscosity of the resin material becomes low in the cylinder of the injection molding machine, so that the difference in the viscosity between the solid phase and the molten phase of the matrix polymer becomes small. Thus, breakage of the long glass fiber filler due to the interaction between the solid phase and the molten phase can be suppressed effectively. As a result, a molded article having a high impact strength can be obtained. In addition, since the melt viscosity of the matrix polymer is low, the wetting property between the matrix polymer and the long glass fiber filler is good. Furthermore, the polypropylene component of the matrix polymer has a pentad isotactic index of 95% or more. In other words, most of the methyl groups of the polypropylene component have the same configuration along the polymer chain, and therefore the polypropylene components are arranged as closely as possible so that the crystallinity is high when solidified. Thus, a molded article having a high bending modulus even if the low molecular weight matrix polymer is used.

Herein, the MFR is an index of the melt viscosity of polymer, and the number of grams of an amount of polymer discharged per 10 min of a circular tube extrusion stream according to JIS K7210 (ASTM D1238). For the conditions of circular tube extrusion, a test temperature and a test load can be selected depending on the type of polymer. In the present invention, the MFR is measured at a test temperature of 230° C. and a test load of 21.18N. The melt viscosity of polymer generally depends on the molecular weight. Polypropylene having a MFR of 100 g/10 min corresponds to polypropylene having a molecular weight of about 125000, and 300 g/10 min corresponds to about 70000. In the present invention, the MFR is required to be 100 to 300 g/10 min. When the MFR is less than 100 g/10 min, the melt viscosity of the matrix polymer becomes high, so that breakage of the long glass fiber filler cannot be suppressed, and thus a molded article having a high impact strength cannot be obtained. On the other hand, when the MFR is higher than 300/10 min, air is contained so that voids are generated in the molded articled, so that the impact strength of the molded article is low on the contrary.

The pentad isotactic index is an index of the tacticity of polymer. Polypropylene has a methyl group per monomer unit, so that stereoisomers. can be formed. When the configuration of the methyl groups along the polymer chain is random, the polymer is referred to as “atactic”. When the configuration is alternate, the polymer is referred to as “syndiotactic”. When the configuration is the same, the polymer is referred to as “isotactic”. Furthermore, regarding two consecutive monomer units in polypropylene, that is, a diad, when the configuration of these methyl groups is the same, this is referred to as “meso (m)”. When the configuration is different, this is referred to as “racemi (r)”. The pentad isotactic index is a ratio of the case where in arbitrary 5 consecutive monomer units, that is, a pentad, the configuration of all of the methyl groups of the pentad is the same (4 consecutive mesos are arranged (mmmm)), and is referred to also as “mmmm index”. Therefore, in polypropylene having a high pentad isotactic index, when solidified, the molecules are oriented regularly so that the crystallinity thereof becomes high. Thus, the bending modulus of the molded article becomes high. The configuration of the methyl groups in a pentad can be determined by the resonance regions of the high resolution ¹³CNMR spectrum as to the type to which the configuration belongs, and the intensity thereof quantifies the ratio. The pentad isotactic index can be obtained by the following equation.

### Equation 1

$$Pentad isotactic index = \frac{mmmm}{\begin{matrix}mmmm + mmmr + rmmr + mmrm + \\ rmrr + mmrr + rmrm + rrrr + mrrr + mrrm\end{matrix}} \times 100$$

In the present invention, the pentad isotactic index of the polypropylene component is required to be 95% or more. When it is lower than 95%, a molded article having a high bending modulus cannot be obtained.

Furthermore, the long glass fiber filler is required to be contained in a ratio of 30 to 50 mass percent of the total mass. When it is lower than 30%, a molded article having a high bending modulus cannot be obtained. On the other hand, when it is higher than 50%, the content of the long glass fiber filler is high so that a molded article having a high bending modulus and a high impact strength can be obtained. However, the viscosity of the resin material is increased so that the flowability is reduced, and therefore the function of the present invention of suppressing breakage of the long glass fiber filler by using a matrix polymer having a low melt viscosity is not properly achieved. Thus, the durability of the molded article may be poor. In particular, in the case where the resin material is forced into a mold by high pressure to form a large-scale molded article, it is highly possible that the long glass fiber filler is broken in the molding machine or in the mold. The present invention is characterized in that a molded article having a high bending modulus and a high impact strength can be realized when the content of the long glass fiber filler is in the range of 30 to 50 mass percent.

In the long glass fiber filler reinforced resin material for molding of the present invention, a composite of a matrix polymer and a long glass fiber filler may be prepared as a masterbatch, and the masterbatch may be diluted with homopolypropylene or the like to prepare the long glass fiber filler reinforced resin material. Furthermore, this composite itself may be used as the long glass fiber filler reinforced resin material.

The affinity providing component may be acid-denatured polypropylene having a functional group that reacts chemically with the coupling agent with which the surface of the long glass fiber filler is treated. This embodiment makes it possible that the acid-denatured portion is chemically bonded to the coupling agent on the surface of the long glass fiber filler and that the polypropylene portion is diffused to the polypropylene component of the matrix polymer, so that strong bonding is formed between the long glass fiber filler and the matrix polymer. In addition, a high affinity is provided between the matrix polymer and the long glass fiber filler. Moreover, the melt viscosity of the matrix polymer is small (the molecular weight is small), and therefore the long glass fiber filler is sufficiently impregnated with the matrix polymer, so that the dispersibility of the long glass fiber filler in the matrix polymer is good. Herein, the acid-denatured polypropylene may be contained in such a manner that it is molten together with the matrix polymer to form a composite with the long glass fiber filler, or the acid-denatured polypropylene may be mixed by being fed together with the composite of the matrix polymer and the long glass fiber into the molding machine. Examples of the acid-denatured polypropylene include polypropylenes that are denatured with maleic anhydride, acrylic acid, or carboxylic acid, and polypropylenes having a hydroxyl group as the functional group. Among these, acid-denatured polypropylene comprising at least one selected from maleic anhydride-denatured polypropylene and acrylic acid-denatured polypropylene as a constituent can be used preferably.

The form of the composite of the matrix polymer and the long glass fiber filler, or the composite of the matrix polymer, the long glass fiber filler and the affinity providing component is not limited to a particular form, but preferably is a 10 to 12 mm rod-shaped pellet, and preferably the long glass fiber filler is aligned in the longitudinal direction of the rod-shaped pellet. This embodiment can eliminate non-uniformity in the content of the long glass fiber filler of the molded article and can ensure sufficient impact strength effectively. More specifically, when the length of the pellet is less than 10 mm, the long glass fiber filler contained in the molded article is short, so that sufficient impact strength cannot be obtained. Furthermore, when the length of the pellet is more than 12 mm, classification or bridge occurs in the hopper, which is an inlet through which the material is fed of the injection molding machine. As a result, the content of the long glass fiber filler in the molded article is not uniform. Such a rod-shaped pellet can be produced by a so-called drawing method including immersing glass fiber bundles in a bath in which the matrix polymer and the like are molten to impregnate the glass fibers with the melt, solidifying the glass fibers impregnated with the melt, and cutting it in the longitudinal direction.

The matrix polymer is not limited to a particular type, as long as it comprises a polypropylene component having a pentad isotactic index of 95% or more, and having a MFR of 100 to 300 g/10 min. The matrix polymer can be an ethylene-propylene block copolymer or the like, or can be homopolypropylene.

When the matrix polymer is homopolypropylene, an ethylene-propylene block copolymer comprising a polypropylene component having a pentad isotactic index of at least 95% may be mixed therewith. According to this embodiment, the ethylene-propylene block copolymer is of an islands-sea structure where domains of polyethylene components are formed in the polypropylene component, and therefore an inflicted impact can be energy-absorbed at the boundary portion between the polypropylene component and the polyethylene component. Thus, the impact strength can be improved further. Herein, the ethylene-propylene block copolymer may be mixed in such a manner that it is molten with the matrix polymer to form a composite with the long glass fiber filler, or the ethylene-propylene block copolymer may be mixed by being fed together with the masterbatch of the composite of the matrix polymer and the long glass fiber filler into the molding machine. In the present invention, the pentad isotactic index of the polypropylene component of the ethylene-propylene block copolymer is required to be 95% or more, because when it is lower than 95%, a molded article having a high bending modulus cannot be obtained.

According to another aspect of the present invention, a long glass fiber filler reinforced resin material for molding comprises a masterbatch comprising a matrix polymer comprising a polypropylene component having a pentad isotactic index of at least 95%; a long glass fiber filler in a content of 30 to 50 mass percent with respect to the total mass; and an affinity providing component for providing affinity between the matrix polymer and the long glass fiber filler, wherein at least the matrix polymer and the long glass fiber filler form a composite; and a diluent polymer comprising a polypropylene component having a pentad isotactic index of at least 95%. The MFR of the matrix polymer of the masterbatch is larger than twice the MFR of the diluent polymer.

According to this embodiment, the MFR of the matrix polymer of the masterbatch is larger than twice the MFR of the diluent polymer. Therefore, the former and the latter have a large difference in the viscosity, and the former has a lower viscosity than that of the latter, so that the former has a better wetting property with respect to the long glass fiber filler. Thus, for example, when the resin material is heated or kneaded in the injection molding machine, the long glass fiber filler is coated and protected with the matrix polymer and maintains this state, so that breakage of the long glass fiber filler can be suppressed effectively. Thus, a molded article having high impact strength can be obtained. Furthermore, the pentad isotactic index of the polypropylene components both of the matrix polymer and the diluent polymer is 95% or more. More specifically, most of the methyl groups have the same configuration along the polymer chain, and the polypropylene molecules are arranged as closely to each other as possible so that the crystallinity is high when solidified. In addition, since the diluent polymer having a lower MFR than that of the matrix polymer contributes to an increase of the strength of the resin component, a molded article having a high bending modulus can be obtained.

Furthermore, the MFR of the matrix polymer is larger than twice the MFR of the diluent polymer, and thus the former and the latter have a large difference in the viscosity, so that the long glass fiber filler is coated and protected with the matrix polymer, and excessive dispersion can be suppressed. As a result, the long glass fiber filler is hardly exposed to the surface of the molded article. In addition, since the matrix polymer has a lower viscosity and a higher flow rate than those of the diluent polymer, the matrix polymer flows while forming a matrix polymer layer in a flow path inner wall, and therefore when the resin material is filled in a mold cavity, the matrix polymer layer is formed in the mold cavity inner wall. As a result, a thick skin layer made of matrix polymer can be formed in the molded article, so that a molded article having significantly good appearance design properties can be obtained.

Preferable examples of the matrix polymer of the masterbatch and the diluent polymer include homopolypropylene and ethylene-propylene block copolymer.

In this case, it is preferable that the matrix polymer of the masterbatch has a MFR of 100 to 300 g/10 min. According to this embodiment, the MFR of the matrix polymer is in appropriately high level (low molecular weight), so that the overall melt viscosity of the resin material, for example, in the cylinder of the injection molding machine is low. Therefore, the viscosity difference between the solid phase and the molten phase of the matrix polymer becomes small, so that breakage of the long glass fiber filler due to an interaction thereof can be suppressed. In addition, since the melt viscosity of the matrix polymer is low, the wetting property between the matrix polymer and the long glass fiber filler is good.

The above-described long glass fiber filler reinforced resin material can be used in any molding such as press molding, uniaxial extrusion forming, biaxial extrusion forming, and injection molding, but has a significantly advantageous function and effect in a molding method that imposes a severe hysteresis on the resin material such as extrusion molding and injection molding including the process of heating and melting the resin component in a cylinder, and kneading the melt under shear flow with a screw.

The characteristics required for an injection-molded article produced by injection-molding a long glass fiber filler reinforced polypropylene resin material comprising a long glass fiber filler in a content of 30 to 50 mass percent are that the weight-average fiber length of the contained glass fiber filler is at least 4 mm, the bending modulus thereof is at least 5 GPa, and the Izod impact value thereof is at least 25 KJ/m². Such levels have not been achieved so far. However, an approach to produce such an injection-molded article is to use the long glass fiber filler reinforced resin material for molding of the present invention in injection molding. Examples of articles that can be produced in such a manner include, but not limited to, a shroud module, a door module, a liftgate module, a bumper module, a step member and a structure instrument panel member for vehicles.

Herein, the weight-average fiber length can be obtained by extracting a predetermined number (500 to 1500) of long glass fibers from the molded article, measuring the length of each fiber, and calculating based on the following equation.

### Equation 2

$$Weight average fiber length = \frac{\sum {( fiber length )}^{2}}{\sum fiber length}$$

Furthermore, the Izod impact value is a value obtained by dividing the absorption energy required to break a test specimen in the Izod impact test method according to JIS K7110 (ASTM D256) by the original cross-section area of the notch portion of the test specimen, and this is an index of impact strength.

Another aspect of the present invention, a method for molding an injection-molded article using an injection molding machine including resin heating means, a screw and a mold, includes feeding a long glass fiber filler reinforced resin material for molding into the injection molding machine, the long glass fiber filler reinforced resin material comprising a composite of homopolypropylene having a pentad isotactic index of at least 95% and a melt flow rate of 100 to 300 g/10 min, and a long glass fiber filler, wherein the composite has the form of a 10 to 12 mm rod-shaped pellet, and the long glass fiber filler is aligned in a longitudinal direction of the rod-shaped pellet; heating the resin material fed into the injection molding machine by the resin heating means, thereby melting a resin component thereof while kneading the resin material by rotating the screw; and injecting the heated and kneaded resin material into the mold, thereby producing an injection-molded article comprising the long glass fiber filler in a content of 30 to 50 mass percent with respect to the total mass, and having a weight-average fiber length of at least 4 mm, a bending modulus of at least 5 GPa, and an Izod impact value of at least 25 KJ/m². In general, a heater provided in the cylinder of the injection molding machine can serve as the resin heating means.

In this method, in order to suppress the long glass fiber filler from breaking, the rotation speed of the screw is preferably 20 to 40 rpm, and the injection filling time of the resin material into the mold is preferably 2.5 to 7.0 seconds.

This method makes it possible to produce an injection-molded article for a shroud module of an automobile that requires high impact strength. In this case as well, it is preferable to satisfy the above conditions for the rotation speed of the screw and the injection filling time of the resin material.

Furthermore, in this method, the long glass fiber filler reinforced resin material for molding can comprise an ethylene-propylene block copolymer comprising a polypropylene component having a pentad isotactic index of 95% or more, so that the impact strength of the injection-molded article can be improved further.

Using a long glass fiber filler reinforced resin material comprising a matrix polymer including a polypropylene component having a pentad isotactic index of at least 95% and having a melt flow rate of 100 to 300 g/10 min; a long glass fiber filler in a content of 30 to 50 mass percent of with respect to a total mass; an affinity providing component for providing affinity between the matrix polymer and the long glass fiber filler, wherein at least the matrix polymer and the long glass fiber filler form a composite, a method including the following process can be performed under more specific conditions. The method includes preparing the above-described resin material; feeding the resin material into the injection molding machine; heating the resin material fed into the injection molding machine by the resin heating means, thereby melting a resin component thereof while kneading the resin material by rotating the screw at a rotation speed of 20 to 60 rpm; and injecting the heated and kneaded resin material into the mold at a back pressure of 2.94×10⁵ to 3.92×10⁵ Pa, an injection filling time of 2.0 to 7.0 seconds, an injection rate of 70 to 90% and an injection pressure of 1.86 to 3.24 MPa; keeping the resin material injected into the mold under dwelling at a pressure of 20 to 45% of the injection pressure for 9 to 20 seconds; and opening the mold to remove an injection-molded article.

Herein, the back pressure refers to the pressure that forces the molten resin material back to the upstream of the cylinder by the fact that the flow path is narrowed at the end of the cylinder of the injection molding machine. The injection filling time refers to the period of time from the start of pouring of the molten resin material into the mold to the completion of filling. The injection rate refers to a mass percent of the resin material injected and filled in the mold by one injection of the molten resin material stored at the end of the cylinder of the injection molding machine. The injection pressure refers to the pressure that acts on the molten resin material when it is injected and filled in the mold. The dwelling refers to keeping a predetermined pressure for a while after the resin material is injected and filled in the mole.

When the back pressure is smaller than 2.94×10⁵ Pa, the resin material is solidified in the gate portion of the mold, so that a complete injection-molded article cannot be obtained. On the other hand, when the back pressure is larger than 3.92×10⁵ Pa, the long glass fiber filler is significantly broken in the process of injecting and filling the resin material. Similarly, when the injection rate is smaller than 70%, the resin material is solidified in the gate portion of the mold, so that a complete injection-molded article cannot be obtained. On the other hand, when the injection rate is larger than 90%, the long glass fiber filler is significantly broken in the process of injecting and filling the resin material. Furthermore, when the pressure for dwelling is lower than 20% of the injection pressure, sink marks are likely to be generated in the injection-molded article. On the other hand, the pressure for dwelling is higher than 45% of the injection pressure, the long glass fiber filler is likely to be broken.

This and other advantages of the present invention will become apparent to those skilled in the art upon reading and understanding the following detailed description with reference to the accompanying figures.

### BRIEF DESCRIPTION OF THE DRAWINGS

FIGS. 1A and 1B are views showing the dispersion states of long glass fibers in a matrix polymer of a pellet.

FIG. 2 is a diagram showing the constitution of an ethylene-propylene block copolymer.

FIG. 3 is a perspective view of a shroud module molded by injection molding.

FIG. 4 is a diagram illustrating the flowing state of a resin material in Embodiment 2.

FIG. 5 is a graph showing the relationship between the ratio of the MFR of a matrix polymer to the MFR of a diluent polymer and the impact strength and the appearance design properties of the injection-molded article.

FIG. 6 and FIG. 7 are tables showing the constitutions of test evaluation samples used in Experiment 1.

FIG. 8 is a table showing the test evaluation results of Experiment 1.

FIGS. 9A to 9C are graphs showing the relationships between the pentad isotactic index of homopolypropylene that is a matrix polymer, and the weight average fiber length, the bending modulus and the Izod impact value of the injection-molded article, respectively, based on the test evaluation results of Experiment 1.

FIGS. 10A to 10C are graphs showing the relationships between the MFR of the matrix polymer and the weight average fiber length, the bending modulus and the Izod impact value of the injection-molded article, respectively, based on the test evaluation results of Experiment 1.

FIGS. 11A and 11C are graphs showing the characteristics of the weight average fiber length, the bending modulus and the Izod impact value of the injection-molded article depending on the presence or the absence of the affinity providing component, respectively, based on the test evaluation results of Experiment 1.

FIGS. 12A to 12C are graphs showing the relationships between the content of acrylic acid-denatured polypropylene and the weight average fiber length, the bending modulus and the Izod impact value of the injection-molded article, respectively, based on the test evaluation results of Experiment 1.

FIGS. 13A to 13C are graphs showing the relationships between the content of maleic anhydride-denatured polypropylene and the weight average fiber length, the bending modulus and the Izod impact value of the injection-molded article, respectively, based on the test evaluation results of Experiment 1.

FIGS. 14A and 14C are graphs showing the characteristics of the weight average fiber length, the bending modulus and the Izod impact value of the injection-molded article when homopolypropylene is used as the diluent polymer mixed with a masterbatch and an ethylene-propylene block copolymer is used as the diluent polymer, respectively, based on the test evaluation results of Experiment 1.

FIGS. 15A and 15C are graphs showing the relationships between the pentad isotactic index of the polypropylene component of an ethylene-propylene block copolymer that is the diluent polymer, and the weight average fiber length, the bending modulus and the Izod impact value of the injection-molded article, respectively, based on the test evaluation results of Experiment 1.

FIGS. 16A and 16C are graphs showing the relationships between the mass percentage of the long glass fiber filler and the bending modulus and the Izod impact value of the injection-molded article, respectively, based on the test evaluation results of Experiment 2.

FIG. 17 is a table showing the injection molding conditions of the test evaluation samples used in Experiment 3.

FIG. 18 is a table showing the temperatures of the injection molding machine in the process of molding of the test evaluation samples used in Experiment 3.

FIG. 19 is a graph showing the results of the flexural fatigue test at 100IC in Experiment 3.

FIG. 20 is a graph showing the results of the flexural fatigue test at 120° C. in Experiment 3.

FIG. 21 is a graph showing the relationship between the Izod impact value and the bending modulus of a conventional injection-molded article and a conventional press-formed article.

FIGS. 22A and 22B are diagrams showing the states of the matrix polymer and the long glass fiber filler in the injection molding machine.

FIG. 23 is a graph showing the relationship between the Izod impact value and the bending modulus of a long glass fiber filler reinforced polypropylene resin for which it is attempted to improve the impact strength by improving the dispersibility of the long glass fiber filler and adding elastomer.

### DETAILED DESCRIPTION OF THE INVENTION

### Embodiment 1

### Long Glass Fiber Filler Reinforced Polypropylene Resin Material

A long glass fiber filler reinforced polypropylene resin material of Embodiment 1 comprises a masterbatch in pellet form and an ethylene-propylene block copolymer in pellet form as a diluent polymer. The masterbatch is a composite comprising a matrix polymer, a long glass fiber filler, and an affinity providing component that provides affinity between the matrix polymer and the long glass fiber filler.

The matrix polymer is homopolypropylene having a pentad isotactic index of 95% or more, and a MRF of 100 to 300 g/10 min. (a molecular weight of 70000 to 125000).

The long glass fiber filler is no-alkali glass such as E-glass, the surface thereof is treated with a coupling agent such as aminosilane.

The affinity providing component is acid-denatured polypropylene such as maleic anhydride-denatured polypropylene or acrylic acid-denatured polypropylene that has a functional group that reacts chemically with the coupling agent with which the surface of the long glass fiber filler is treated, and is easily diffused to homopolypropylene that is the matrix polymer. In this case, the mixing ratio of the homopolypropylene and the acid-denatured polypropylene is 5 to 95% for the former, and 95 to 5% for the latter.

The pellet of the masterbatch has a shape of a rod of 10 to 12 mm length, and the long glass fiber filler is aligned in the longitudinal direction of the rod-shaped pellet. Such a masterbatch in pellet form can be produced by a so-called drawing method including the processes of immersing glass fiber bundles in a bath which homopolypropylene and acid-denatured polypropylene are molten to impregnate the glass fibers with the melt, solidifying the glass fibers impregnated with the melt, and cutting it in the longitudinal direction.

The pentad isotactic index of the polypropylene component of the ethylene-propylene block copolymer mixed with the masterbatch as the diluent polymer is 95% or more. The ethylene-propylene block copolymer as the diluent polymer is mixed with the masterbatch, so that the content of the long glass fiber filler is 30 to 50 mass percent with respect to the total mass.

When the long glass fiber filler reinforced polypropylene resin material having the above constitution is used, the MFR of the matrix polymer is in appropriately high level (low molecular weight), so that the overall melt viscosity of the resin material in the cylinder of the injection molding machine is low. Therefore, the viscosity difference between the solid phase and the molten phase of the matrix polymer becomes small, so that breakage of the long glass fiber filler due to an interaction thereof can be suppressed so that a molded article having a high impact strength can be obtained. In addition, since the melt viscosity of the matrix polymer is low, the wetting property between the matrix polymer and the long glass fiber filler is good. Furthermore, the homopolypropylene of the matrix polymer has a pentad isotactic index of 95% or more. More specifically, since most of the methyl groups have the same configuration along the polymer chain, the molecules are arranged as closely to each other as possible so that the crystallinity is high when solidified. Therefore, a molded article having a high bending modulus can be obtained even if the low molecular weight matrix polymer is used.

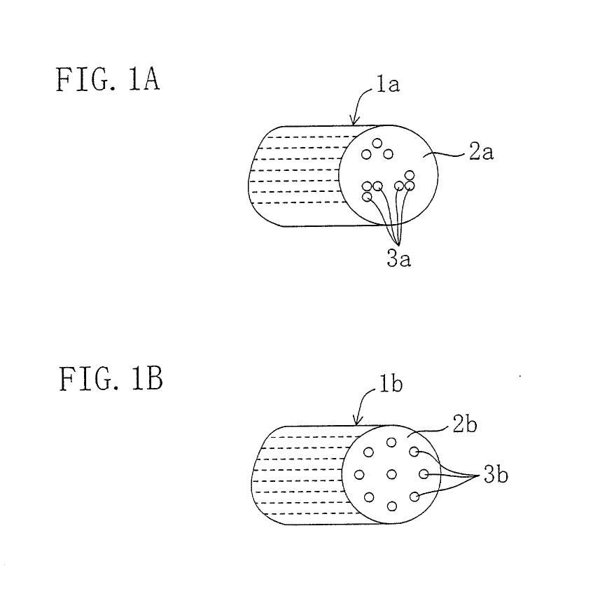

Furthermore, since as the affinity providing component, acid-denatured polypropylene such as maleic anhydride-denatured polypropylene or acrylic acid-denatured polypropylene is used, the acid-denatured portion is chemically bonded to the coupling agent on the surface of the long glass fiber filler and the polypropylene portion is diffused to homopolypropylene of the matrix polymer, so that strong bonding is formed between the long glass fiber filler and the matrix polymer. Furthermore, when impregnation of the long glass fiber filler with the matrix polymer is not sufficient in production of the masterbatch by a drawing method, as shown in FIG. 1A, in the obtained pellet 1a, long glass fibers 3a are not sufficiently dispersed in a matrix polymer 2a. However, by using the acid-denatured polypropylene in Embodiment 1, high affinity is provided between the matrix polymer and the glass fibers, and also because the melt viscosity of the matrix polymer is low (the molecular weight is low), the long glass fibers are sufficiently impregnated with the matrix polymer. Thus, as shown in FIG. 1B, the dispersibility of the long glass fibers 3b in the matrix polymer 2b of the pellet 1b is good.

The masterbatch has a rod-shaped pellet form of 10 to 12 mm length, and the long glass fiber filler is aligned in the longitudinal direction of the rod, so that the content of the long glass fiber filler in the obtained molded article is uniform, and sufficient impact strength can be obtained without fail.

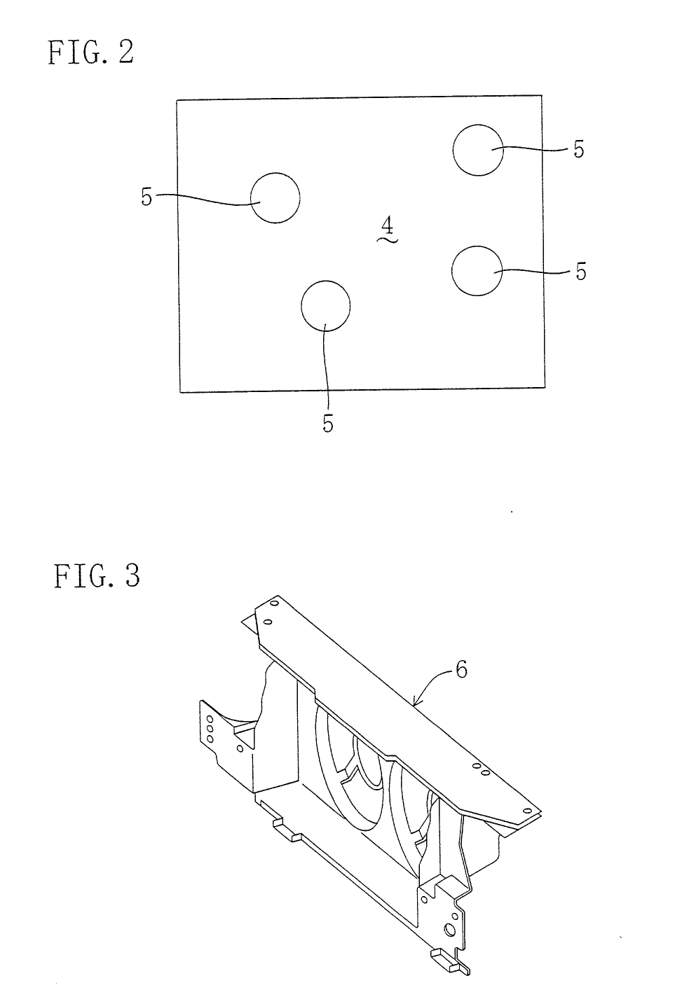

Furthermore, an ethylene-propylene block copolymer comprising a polypropylene component having a pentad isotactic index of 95% or more is mixed with the masterbatch as the diluent polymer. The ethylene-propylene block copolymer has an islands-sea structure in which the domains of a polyethylene component 5 are formed in a polypropylene component 4, as shown in FIG. 2, and therefore an inflicted impact is energy-absorbed in the boundary portion between the polypropylene component 4 and the polyethylene component 5, so that the impact strength of the obtained molded article can be improved further.

### Injection Molding Machine

The long glass fiber filler reinforced polypropylene resin material is injection-molded by an injection molding machine.

In this injection molding machine, the pitch and the flight groove of a flight provided in a screw are larger than those of a conventional machine, so that the shearing force imposed on the long glass fiber filler can be reduced at the flight portion. Furthermore, the path for the resin material in a backflow preventer valve is larger than that of a conventional machine, and no splines are provided in a sprue so that the shearing force imposed on the long glass fiber filler in the head portion of the injection molding machine can be reduced. The improved injection molding machine with these features prevents breakage of the long glass fiber filler of the resin material.

Molding of a molded article using such an injection molding machine can be performed in the following procedures.

First, the long glass fiber filler reinforced polypropylene resin material of Embodiment 1 is prepared.

Then, the prepared resin material is fed into the injection molding machine through a hopper.

Then, the resin material fed into the injection molding material is heated in the cylinder of the injection molding machine, so that the resin component is molten and the screw is rotated to knead the resin material.

Then, the heated and kneaded resin material is injected into a mold cavity in a mold.

Then, the injected resin material in the mold is put under dwelling for a predetermined period of time.

Finally, the mold is opened and a molded article is removed therefrom.

Preferable molding conditions in this case are as follows. The resin temperature is 240 to 260° C.; the mold temperature is 50 to 80° C.; the screw rotation rate is 20 to 60 rpm; the back pressure is 0 to 9.80×10⁵ Pa (more preferably, 2.94×10⁵ to 3.92×10⁵ Pa); the injection speed (injection filling time) is 2.0 to 7.0 seconds; the injection rate is 70 to 90%; the injection pressure is 1.86 to 3.24 MPa, the pressure for dwelling is 20 to 45% of the injection pressure; and the period of time for dwelling is 9 to 20 seconds.

### Injection-molded Article

FIG. 3 shows a shroud module 6 molded by feeding the long glass fiber filler reinforced polypropylene resin material into the above-described injection molding machine. The shroud module 6 is an integrally formed unit including a shroud upper, a shroud side member, a head lamp support, a radiator, and a condenser support, a cooling fan motor support, a bonnet latch support, or the like.

In the resin material for the shroud module 6, the matrix polymer in the masterbatch is homopolypropylene having a pentad isotactic index of 95% or more and a MFR of 100 to 300 g/10 min. Furthermore, the mass percentage of the long glass fiber filler is 30 to 50% of the total mass. Therefore, this shroud module 6 is an injection-molded article in which breakage of the long glass fiber filler is effectively suppressed, and that has a high bending modulus and a high impact strength. More specifically, the weight-average fiber length of the contained long glass fiber filler is 4 mm or more, the bending modulus is 5 GPa or more, and the Izod impact value is 25 KJ/m² or more. Such levels have not been achieved so far in a shroud module molded by injection-molding a resin material containing 30 to 50% of the long glass fiber filler.

Furthermore, the shroud module conventionally constituted by 23 parts can be obtained as an integral unit by injection molding, so that the number of parts can be reduced and the cost can be reduced.

### Embodiment 2

### Long Glass Fiber Filler Reinforced Polypropylene Resin Material

A long glass fiber filler reinforced polypropylene resin material of Embodiment 2 comprises a masterbatch in pellet form and an ethylene-propylene block copolymer in pellet form as a diluent polymer. The masterbatch is a composite comprising a matrix polymer, a long glass fiber filler, and an affinity providing component that provides affinity between the matrix polymer and the long glass fiber filler.

The matrix polymer is homopolypropylene having a pentad isotactic index of 95% or more, and a MRF of 100 to 300 g/10 min. (a molecular weight of 70000 to 125000).

The long glass fiber filler is no-alkali glass such as E-glass, the surface thereof is treated with a coupling agent such as aminosilane.

The affinity providing component is acid-denatured polypropylene such as maleic anhydride-denatured polypropylene or acrylic acid-denatured polypropylene that has a functional group that reacts chemically with the coupling agent with which the surface of the long glass fiber filler is treated, and is easily diffused to homopolypropylene that is the matrix polymer. In this case, the mixing ratio of the homopolypropylene and the acid-denatured polypropylene is 5 to 95% for the former, and 95 to 5% for the latter.

The pellet of the masterbatch has a shape of a rod of 10 to 12 mm length, and the long glass fiber filler is aligned in the longitudinal direction of the rod. Such a masterbatch in pellet form can be produced by a so-called drawing method including the processes of immersing glass fiber bundles in a bath in which homopolypropylene and acid-denatured polypropylene are molten to impregnate the glass fibers with the melt, solidifying the glass fibers impregnated with the melt, and cutting it in the longitudinal direction.

The pentad isotactic index of the polypropylene component of the ethylene-propylene block copolymer mixed with the masterbatch as the diluent polymer is 95% or more. The ethylene-propylene block copolymer as the diluent polymer is mixed with the masterbatch, so that the content of the long glass fiber filler is 30 to 50 mass percent with respect to the total mass.

As described above, the MFR of the homopolypropylene of the matrix polymer of the masterbatch is 100 to 300 g/10 min., which is larger than twice the MFR of the ethylene-propylene block copolymer of the diluent polymer. In other words, the homopolypropylene of the matrix polymer and the ethylene-propylene block copolymer of the diluent polymer have a difference in the viscosity, and the viscosity of the former is lower than that of the latter.

The long glass fiber filler reinforced polypropylene resin material of Embodiment 2 is used for molding of an article such as a shroud module molded by injection molding using the same injection molding machine as in Embodiment 1.

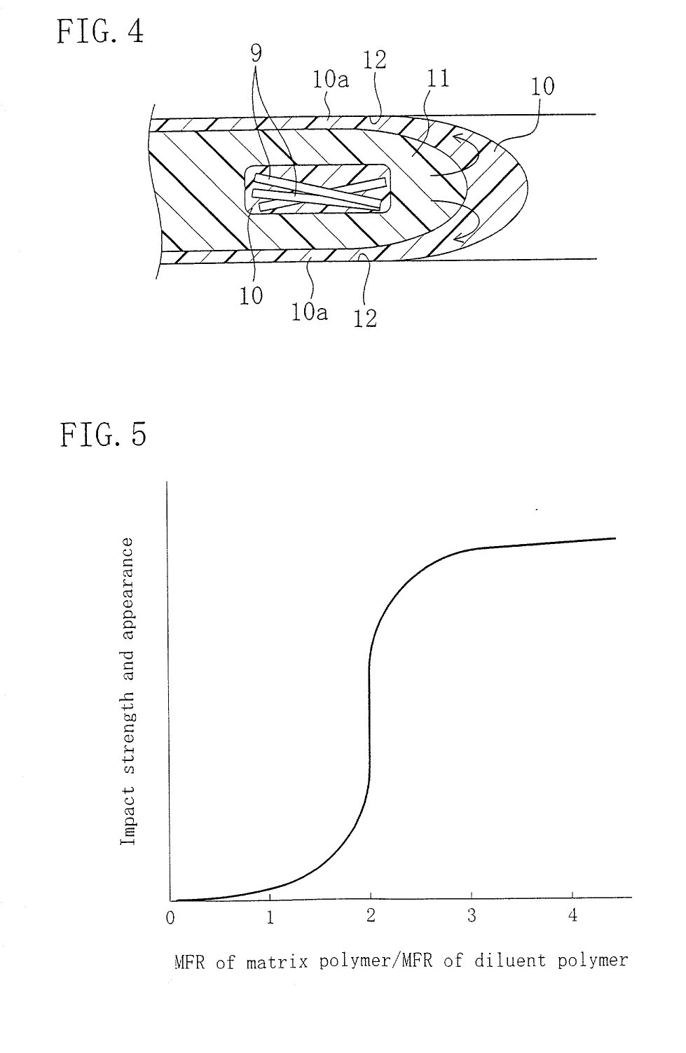

The above-described long glass fiber filler reinforced polypropylene resin material has the following advantages. Since the MFR of the homopolypropylene of the matrix polymer of the masterbatch is larger than twice the MFR of the ethylene-propylene block copolymer of the diluent polymer, the former and the latter have a large difference in the viscosity. In addition, since the former has a lower viscosity than that of the latter, the wetting property of the former with respect to the long glass fiber filler is higher. For example, when the resin material is heated and kneaded in the injection molding machine, as shown in FIG. 4, the long glass fiber filler 9 is coated and protected with homopolypropylene 10 and maintains that state, so that breakage of the long glass fiber filler can be effectively suppressed. Thus, a molded article having a high impact strength, as shown in FIG. 5, can be obtained. In addition, since the MFR of homopolypropylene is 100 to 300 g/10 min., the overall melt viscosity of the resin material, for example, in the cylinder of the injection molding machine is low. Therefore, the viscosity difference between the solid phase and the molten phase of the homopolypropylene becomes small, so that breakage of the long glass fiber filler due to an interaction thereof can be suppressed so that a molded article having an even higher impact strength can be obtained by this function. Furthermore, the polypropylene components of both the homopolypropylene and the ethylene-propylene block copolymer have a pentad isotactic index of 95% or more. More specifically, most of the methyl groups have the same configuration along the polymer chain, and the polypropylene molecules are arranged as closely to each other as possible so that the crystallinity is high when solidified. In addition, since the ethylene-propylene block copolymer having a lower MFR than that of homopolypropylene contributes to an increase of the strength of the resin component, a molded article having a high bending modulus can be obtained.

Furthermore, the MFR of the homopolypropylene is larger than twice the MFR of the ethylene-propylene block copolymer, and thus the former and the latter have a large difference in the viscosity, so that the long glass fiber filler is coated and protected with homopolypropylene. Moreover, excessive dispersion can be suppressed, so that the long glass fiber filler is hardly exposed to the surface of the molded article. In addition, as shown in FIG. 4, since the homopolypropylene 10 has a lower viscosity and a higher flow rate than those of the ethylene-propylene block copolymer 11, the homopolypropylene 10 flows while forming a homopolypropylene layer 10a in a flow path inner wall 12, and therefore when the resin material is filled in a mold cavity, the homopolypropylene layer is formed in the mold cavity inner wall. As a result, a thick skin layer made of homopolypropylene can be formed in the molded article, so that, as shown in FIG. 5, a molded article having significantly good appearance design properties can be obtained.

Other functions and effects are the same as in Embodiment 1.

### Other Embodiments

Although in Embodiment 1, the ethylene-propylene block copolymer is mixed with the masterbatch to form the long glass fiber filler reinforced polypropylene resin material, the masterbatch having 30 to 50 mass percent of the long glass fiber filler without the ethylene-propylene block copolymer can be used as a resin material.

In Embodiments 1 and 2, the ethylene-propylene block copolymer is mixed with the masterbatch as the diluent polymer to form the long glass fiber filler reinforced polypropylene resin material. However, the present invention is not limited thereto. Homopolypropylene having a pentad isotactic index of 95% or more can be mixed as the diluent polymer.

In Embodiment 1, the shroud module 6 is molded by injection molding, but the present invention is not limited thereto. For example, the following articles can be molded as a molded article having a sufficient strength; a door module that is a door inner panel integrally molded as one unit including a glass rising and falling member support, and a trim support or the like; a liftgate module that is a liftgate inner panel integrally molded as one unit including a rear wiper driving member support, a trim support or the like; a bumper module integrally molded as one unit including a reinforcement, an impact absorbing member or the like; a step member used when getting off and on that is provided in a lower portion of a side door or a liftgate of vehicles; and a structure instrument panel member in which an instrument panel cross member, a steering bracket, an air duct, a center console member and the like are integrally formed.

### Experiment 1

### Test Evaluation Samples

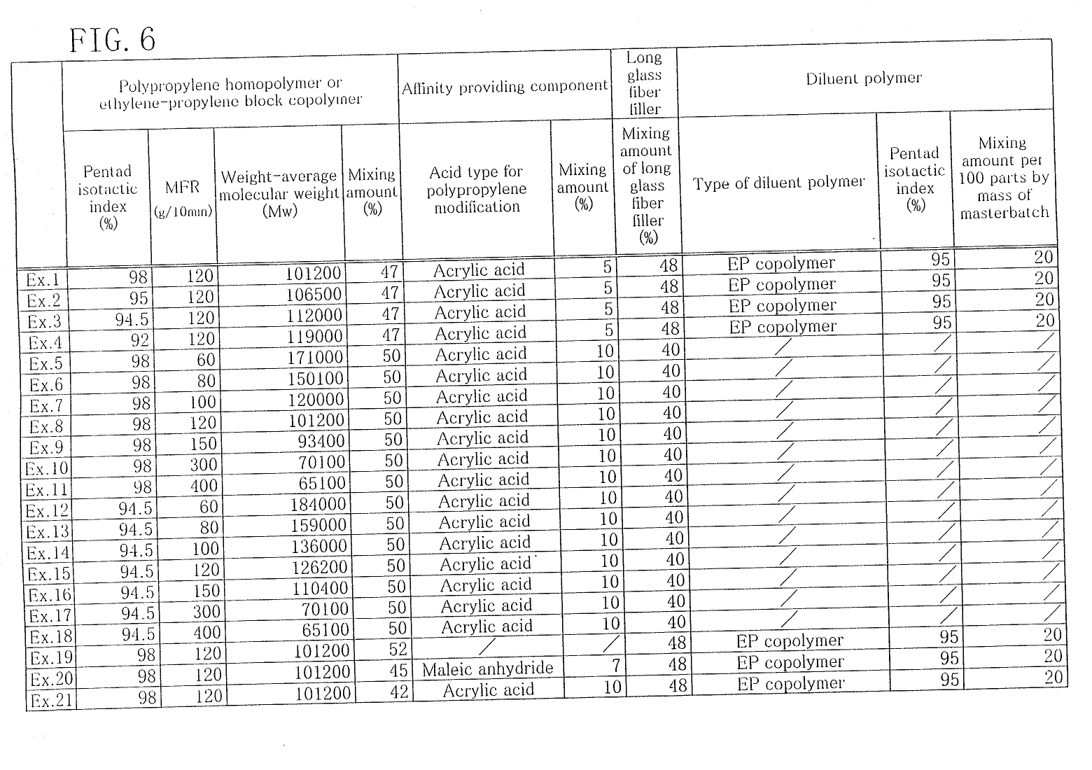

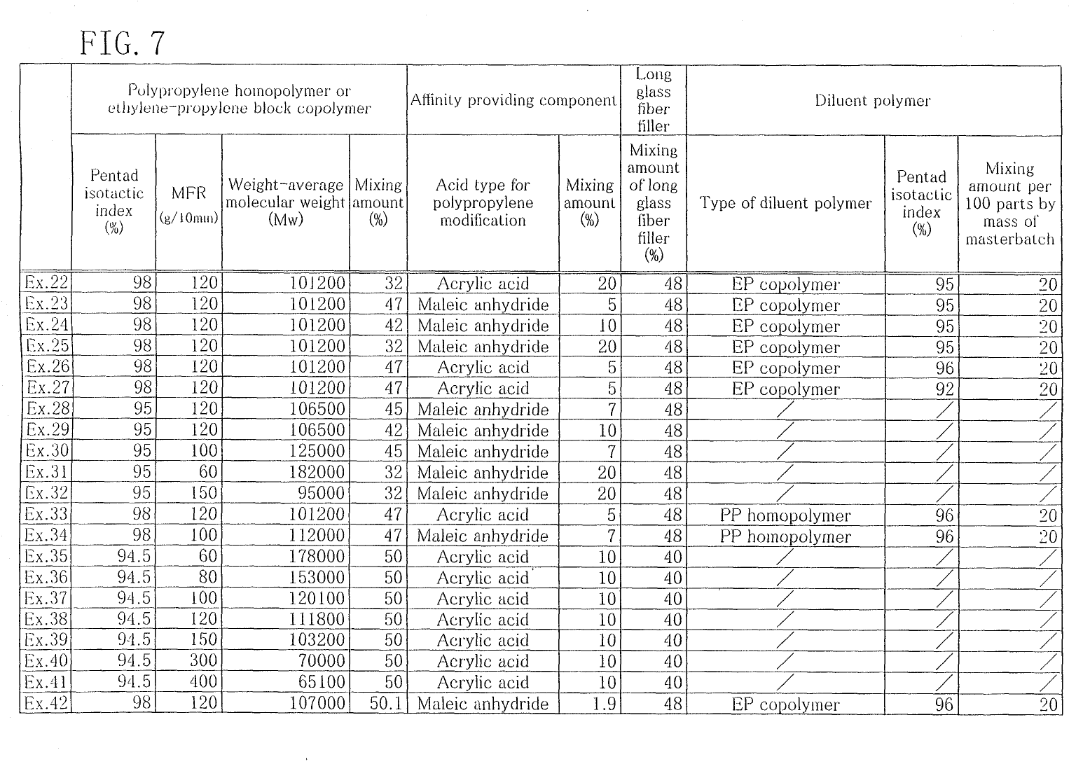

The long glass fiber filler reinforced polypropylene resin materials of the following examples were prepared as test evaluation samples. FIGS. 6 and 7 show the constitutions of the examples.

### EXAMPLE 1

Glass fiber bundles were immersed in a melt of homopolypropylene having a pentad isotactic index of 98% and a MFR of 120 g/10 min (weight-average molecular weight Mw=101200) and acrylic acid-denatured polypropylene. Thereafter, the glass fibers impregnated with the melt were solidified, and then were cut to an average length of 10 mm in the longitudinal direction to prepare a masterbatch in pellet form. This masterbatch was constituted by 47 mass percent of the homopolypropylene, 5 mass percent of the acrylic acid-denatured polypropylene and 48 mass percent of the long glass fiber filler.

With respect to 100 parts by mass of the masterbatch, 20 parts by mass of an ethylene-propylene block copolymer comprising a polypropylene component having a pentad isotactic index of 95% and having a MFR of 30 g/10 min in pellet form as a diluent polymer was mixed. The thus composed long glass fiber filler reinforced polypropylene resin material was denoted as Example 1. The mass percentage of the long glass fiber filler with respect to the total mass was made 40% by dilution.

### EXAMPLE 2

A long glass fiber filler reinforced polypropylene resin material of Example 2 was prepared in the same manner as in Example 1, except that homopolypropylene having a pentad isotactic index of 95% and a MFR of 120 g/10 min (Mw=106500) was used as the homopolypropylene.

### EXAMPLE 3

A long glass fiber filler reinforced polypropylene resin material of Example 3 was prepared in the same manner as in Example 1, except that homopolypropylene having a pentad isotactic index of 94.5% and a MFR of 120 g/10 min (Mw=112000) was used as the homopolypropylene.

### EXAMPLE 4

A long glass fiber filler reinforced polypropylene resin material of Example 4 was prepared in the same manner as in Example 1, except that homopolypropylene having a pentad isotactic index of 92% and a MFR of 120 g/10 min (Mw=119000) was used as the homopolypropylene.

### EXAMPLE 5

Glass fiber bundles were immersed in a melt of homopolypropylene having a pentad isotactic index of 98% and a MFR of 60 g/10 min (Mw=171000) and acrylic acid-denatured polypropylene polymer. Thereafter, the glass fibers impregnated with the melt were solidified and then cut to an average length of 10 mm in the longitudinal direction to prepare a long glass fiber filler reinforced polypropylene resin material in pellet form, which was denoted as Example 5. The resin material was constituted by 50 mass percent of the homopolypropylene, 10 mass percent of the acrylic acid-denatured polypropylene polymer and 40 mass percent of the long glass fiber filler.

### EXAMPLE 6

A long glass fiber filler reinforced polypropylene resin material of Example 6 was prepared in the same manner as in Example 5, except that homopolypropylene having a MFR of 80 g/10 min (Mw=150100) was used as the homopolypropylene.

### EXAMPLE 7

A long glass fiber filler reinforced polypropylene resin material of Example 7 was prepared in the same manner as in Example 5, except that homopolypropylene having a MFR of 100 g/10 min (Mw=120000) was used as the homopolypropylene.

### EXAMPLE 8

A long glass fiber filler reinforced polypropylene resin material of Example 8 was prepared in the same manner as in Example 5, except that homopolypropylene having a MFR of 120 g/10 min (Mw=101200) was used as the homopolypropylene.

### EXAMPLE 9

A long glass fiber filler reinforced polypropylene resin material of Example 9 was prepared in the same manner as in Example 5, except that homopolypropylene having a MFR of 150 g/10 min (Mw=93400) was used as the homopolypropylene.

### EXAMPLE 10

A long glass fiber filler reinforced polypropylene resin material of Example 10 was prepared in the same manner as in Example 5, except that homopolypropylene having a MFR of 300 g/10 min (Mw=70100) was used as the homopolypropylene.

### EXAMPLE 11

A long glass fiber filler reinforced polypropylene resin material of Example 11 was prepared in the same manner as in Example 5, except that homopolypropylene having a MFR of 400 g/10 min (Mw=65100) was used as the homopolypropylene.

### EXAMPLE 12

A long glass fiber filler reinforced polypropylene resin material of Example 12 was prepared in the same manner as in Example 5, except that homopolypropylene having a pentad isotactic index of 94.5% and a MFR of 60 g/10 min (Mw=184000) was used as the homopolypropylene.

### EXAMPLE 13

A long glass fiber filler reinforced polypropylene resin material of Example 13 was prepared in the same manner as in Example 12, except that homopolypropylene having a MFR of 80 g/10 min (Mw=159000) was used as the homopolypropylene.

### EXAMPLE 14

A long glass fiber filler reinforced polypropylene resin material of Example 14 was prepared in the same manner as in Example 12, except that homopolypropylene having a MFR of 100 g/10 min (Mw=136000) was used as the homopolypropylene.

### EXAMPLE 15

A long glass fiber filler reinforced polypropylene resin material of Example 15 was prepared in the same manner as in Example 12, except that homopolypropylene having a MFR of 120 g/10 min (Mw=126200) was used as the homopolypropylene.

### EXAMPLE 16

A long glass fiber filler reinforced polypropylene resin material of Example 16 was prepared in the same manner as in Example 12, except that homopolypropylene having a MFR of 150 g/10 min (MW=110400) was used as the homopolypropylene.

### EXAMPLE 17

A long glass fiber filler reinforced polypropylene resin material of Example 17 was prepared in the same manner as in Example 12, except that homopolypropylene having a MFR of 300q/10 min (MW=70100) was used as the homopolypropylene.

### EXAMPLE 18

A long glass fiber filler reinforced polypropylene resin material of Example 18 was prepared in the same manner as in Example 12, except that homopolypropylene having a MFR of 400 g/10 min (Mw=65100) was used as the homopolypropylene.

### EXAMPLE 19

A long glass fiber filler reinforced polypropylene resin material of Example 19 was prepared in the same manner as in Example 1, except that the masterbatch is constituted by 52% of the homopolypropylene and 48% of the long glass fiber filler. In other words, the acid-denatured polypropylene polymer was not contained in the masterbatch of Example 19.

### EXAMPLE 20

Glass fiber bundles were immersed in a melt of homopolypropylene having a pentad isotactic index of 98% and a MFR of 120 g/10 min (weight-average molecular weight Mw=101200) and maleic anhydride-denatured polypropylene polymer. Thereafter, the glass fibers impregnated with the melt were solidified and then cut to an average length of 10 mm in the longitudinal direction to prepare a masterbatch in pellet form. This masterbatch was constituted by 45 mass percent of the homopolypropylene, 7 mass percent of the maleic anhydride-denatured polypropylene polymer and 48 mass percent of the long glass fiber filler.

With respect to 100 parts by mass of the masterbatch, 20 parts by mass of an ethylene-propylene block copolymer comprising a polypropylene component having a pentad isotactic index of 95% and having a MFR of 30 g/10 min in pellet form as a diluent polymer was mixed. The thus composed long glass fiber filler reinforced polypropylene resin material was denoted as Example 20. The mass percentage of the long glass fiber filler with respect to the total mass was made 40% by dilution.

### EXAMPLE 21

A long glass fiber filler reinforced polypropylene resin material of Example 21 was prepared in the same manner as in Example 1, except that the masterbatch is constituted by 42 mass percent of the homopolypropylene, 10 mass percent of the acrylic acid-denatured polypropylene polymer and 48 mass percent of the long glass fiber filler.

### EXAMPLE 22

A long glass fiber filler reinforced polypropylene resin material of Example 22 was prepared in the same manner as in Example 1, except that the masterbatch is constituted by 32 mass percent of the homopolypropylene, 20 mass percent of the acrylic acid-denatured polypropylene polymer and 48 mass percent of the long glass fiber filler.

### EXAMPLE 23

A long glass fiber filler reinforced polypropylene resin material of Example 23 was prepared in the same manner as in Example 20, except that the masterbatch is constituted by 47 mass percent of the homopolypropylene, 5 mass percent of the maleic anhydride-denatured polypropylene polymer and 48 mass percent of the long glass fiber filler.

### EXAMPLE 24

A long glass fiber filler reinforced polypropylene resin material of Example 24 was prepared in the same manner as in Example 20, except that the masterbatch is constituted by 42 mass percent of the homopolypropylene, 10 mass percent of the maleic anhydride-denatured polypropylene polymer and 48 mass percent of the long glass fiber filler.

### EXAMPLE 25

A long glass fiber filler reinforced polypropylene resin material of Example 25 was prepared in the same manner as in Example 20, except that the masterbatch is constituted by 32 mass percent of the homopolypropylene, 20 mass percent of the maleic anhydride-denatured polypropylene polymer and 48 mass percent of the long glass fiber filler.

### EXAMPLE 26

A long glass fiber filler reinforced polypropylene resin material of Example 26 was prepared in the same manner as in Example 1, except that an ethylene-propylene block copolymer comprising a polypropylene component having a pentad isotactic index of 96% in pellet form was used as the diluent polymer.

### EXAMPLE 27

A long glass fiber filler reinforced polypropylene resin material of Example 27 was prepared in the same manner as in Example 1, except that an ethylene-propylene block copolymer comprising a polypropylene component having a pentad isotactic index of 92% in pellet form was used as the diluent polymer.

### EXAMPLE 28

Glass fiber bundles were immersed in a melt of homopolypropylene having a pentad isotactic index of 95% and a MFR of 120 g/10 min (Mw=106500) and maleic anhydride-denatured polypropylene polymer. Thereafter, the glass fibers impregnated with the melt were solidified and then cut to an average length of 10 mm in the longitudinal direction to prepare a long glass fiber filler reinforced polypropylene resin material in pellet form, which was denoted as Example 28. This resin material was constituted by 45 mass percent of the homopolypropylene, 7 mass percent of the acrylic acid-denatured polypropylene polymer and 48 mass percent of the long glass fiber filler.

### EXAMPLE 29

A long glass fiber filler reinforced polypropylene resin material of Example 29 was prepared in the same manner as in Example 28, except that the resin material is constituted by 42 mass percent of the homopolypropylene, 10 mass percent of the maleic anhydride-denatured polypropylene polymer and 48 mass percent of the long glass fiber filler.

### EXAMPLE 30

A long glass fiber filler reinforced polypropylene resin material of Example 30 was prepared in the same manner as in Example 28, except that homopolypropylene having a MFR of 100 g/10 min (Mw=123000) was used as the homopolypropylene.

### EXAMPLE 31

Glass fiber bundles were immersed in a melt of homopolypropylene having a pentad isotactic index of 95% and a MFR of 60 g/10 min (Mw=182000) and maleic anhydride-denatured polypropylene polymer. Thereafter, the glass fibers impregnated with the melt were solidified and then cut to an average length of 10 mm in the longitudinal direction to prepare a long glass fiber filler reinforced polypropylene resin material in pellet form, which was denoted as Example 31. This resin material was constituted by 32 mass percent of the homopolypropylene, 20 mass percent of the maleic anhydride-denatured polypropylene polymer and 48 mass percent of the long glass fiber filler.

### EXAMPLE 32

A long glass fiber filler reinforced polypropylene resin material of Example 32 was prepared in the same manner as in Example 31, except that homopolypropylene having a MFR of 150 g/10 min (Mw=95000) was used as the homopolypropylene.

### EXAMPLE 33

A long glass fiber filler reinforced polypropylene resin material of Example 33 was prepared in the same manner as in Example 1, except that homopolypropylene in pellet form having a pentad isotactic index of 96% was used as the diluent polymer.

### EXAMPLE 34

A long glass fiber filler reinforced polypropylene resin material of Example 34 was prepared in the same manner as in Example 20, except that homopolypropylene in pellet form having a pentad isotactic index of 96% was used as the diluent polymer.

### EXAMPLE 35

Glass fiber bundles were immersed in a melt of an ethylene-propylene block copolymer comprising a polypropylene component having a pentad isotactic index of 94.5% and having a MFR of 60 g/10 min (Mw=178000) and acrylic acid-denatured polypropylene polymer. Thereafter, the glass fibers impregnated with the melt were solidified and then cut to an average length of 10 mm in the longitudinal direction to prepare a long glass fiber filler reinforced polypropylene resin material in pellet form, which was denoted as Example 35. This resin material was constituted by 50 mass percent of the ethylene-propylene block copolymer, 10 mass percent of the acrylic acid-denatured polypropylene polymer and 40 mass percent of the long glass fiber filler.

### EXAMPLE 36

A long glass fiber filler reinforced polypropylene resin material of Example 36 was prepared in the same manner as in Example 35, except that an ethylene-propylene block copolymer having a MFR of 80 g/10 min (Mw=153000) was used as the ethylene-propylene block copolymer.

### EXAMPLE 37

A long glass fiber filler reinforced polypropylene resin material of Example 37 was prepared in the same manner as in Example 35, except that an ethylene-propylene block copolymer having a MFR of 100 g/10 min (Mw=120100) was used as the ethylene-propylene block copolymer.

### EXAMPLE 38

A long glass fiber filler reinforced polypropylene resin material of Example 38 was prepared in the same manner as in Example 35, except that an ethylene-propylene block copolymer having a MFR of 120 g/10 min (Mw=111800) was used as the ethylene-propylene block copolymer.

### EXAMPLE 39

A long glass fiber filler reinforced polypropylene resin material of Example 39 was prepared in the same manner as in Example 35, except that an ethylene-propylene block copolymer having a MFR of 150 g/10 min (Mw=103200) was used as the ethylene-propylene block copolymer.

### EXAMPLE 40

A long glass fiber filler reinforced polypropylene resin material of Example 40 was prepared in the same manner as in Example 35, except that an ethylene-propylene block copolymer having a MFR of 300 g/10 min (Mw=70000) was used as the ethylene-propylene block copolymer.

### EXAMPLE 41

A long glass fiber filler reinforced polypropylene resin material of Example 41 was prepared in the same manner as in Example 35, except that an ethylene-propylene block copolymer having a MFR of 400 g/10 min (Mw=65100) was used as the ethylene-propylene block copolymer.

### EXAMPLE 42

Glass fiber bundles were immersed in a melt of homopolypropylene having a pentad isotactic index of 98% and a MFR of 120 g/10 min (weight-average molecular weight Mw=107000) and maleic anhydride -denatured polypropylene. Thereafter, the glass fibers impregnated with the melt were solidified, and then were cut to an average length of 10 mm in the longitudinal direction to prepare a masterbatch in pellet form. This masterbatch was constituted by 50.1 mass percent of the homopolypropylene, 1.9 mass percent of the maleic anhydride-denatured polypropylene and 48 mass percent of the long glass fiber filler.

With respect to 100 parts by mass of the masterbatch, 20 parts by mass of an ethylene-propylene block copolymer comprising a polypropylene component having a pentad isotactic index of 96% and having a MFR of 30 g/10 min in pellet form as a diluent polymer was mixed. The thus composed long glass fiber filler reinforced polypropylene resin material was denoted as Example 42. The mass percentage of the long glass fiber filler with respect to the total mass was made 48% by dilution.

### Test Evaluation Method

### Weight-average Fiber Length

A plate-like test specimen was injection-molded with the prepared long glass fiber filler reinforced polypropylene resin material of each example. Then, about 1000 long glass fibers were extracted from the molded test specimen and the length of each glass fiber was measured. The weight-average fiber length was calculated for each sample according to the following equation: Equation 3

$$Weight average fiber length = \frac{\sum {( fiber length )}^{2}}{\sum fiber length}$$

### Bending Modulus

A plate-like test specimen was injection-molded with the prepared long glass fiber filler reinforced polypropylene resin material of each example. Then, bending test was performed with these test specimens according to JIS K7171 (ASTM D790).

Then, the bending modulus was obtained from the obtained test chart.

### Izod Impact Value

A rod-shaped body having a length of 64.0 mm and a square section of 12.7 mm length for each side was injection-molded with the prepared long glass fiber filler reinforced polypropylene resin material of each example. Then, a notch was provided with each rod-shaped body and a 2-A test specimen was prepared, according to the Izod impact test method of JIS K7110 (ASTM D256). In this case, the width, etc. of the notch portion of each test specimen was measured. Then, the Izod impact test was performed according to the standard of JIS with the test specimens.

Then, the absorption energy (E) required for breaking the test specimen was calculated from the moment (WR) of the circumference of the rotation axis of a hammer, the angle (a) when the hammer is lifted, the angle (β) when the hammer rises after test specimen breakage, and the energy loss (L) at the impact test, based on the following equation:

### Equation 4

E=WR(cos α−cos β)−L

Furthermore, the Izod impact value (α_{kI}) was obtained from the absorption energy (E), the width (b) of the notch portion of the test specimen, the thickness (t) around the notch portion of the test specimen, and the depth (d) of the notch portion of the test specimen, based on the following equation.

### Equation 5

$${a}_{kl} = \frac{E}{b ( t - d )} \times 1000$$

### Test Evaluation Results

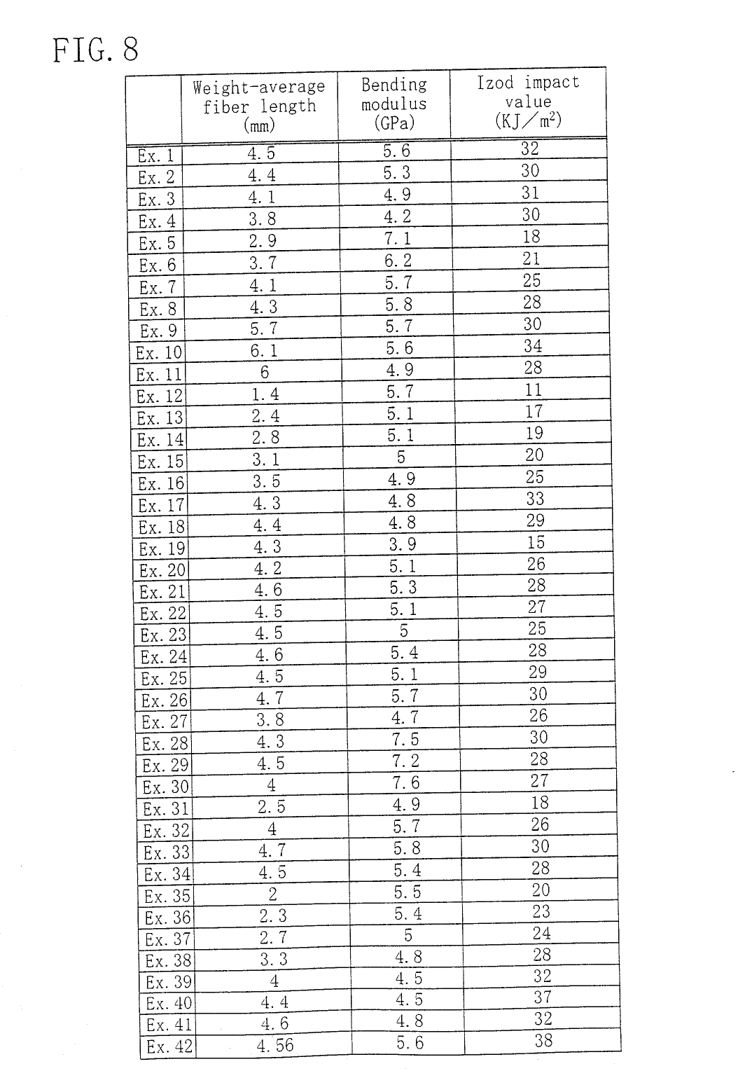

FIG. 8 shows the test evaluation results.

### Effects of the Pentad Isotactic Index of Polypropylene of the Matrix Polymer

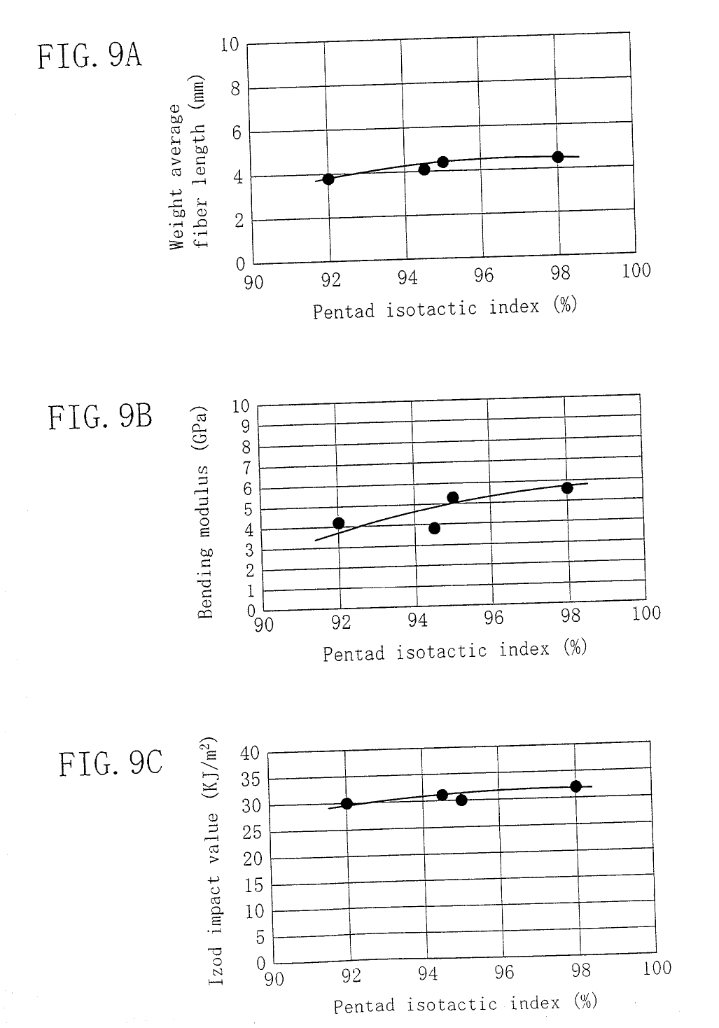

FIGS. 9A to 9C show the relationships between the pentad isotactic index, and the weight-average fiber length, the bending modulus, and the Izod impact value, respectively, based on the test results of Examples 1 to 4.

FIGS. 9A to 9C indicate that the weight-average fiber length, the bending modulus, and the Izod impact value are improved, as the pentad isotactic index of homopolypropylene is increased.

The reason why the weight-average fiber length is increased is not clear. However, in Examples 1 to 4, the masterbatch comprising homopolypropylene having a MFR of 120 g/10 min is mixed with the ethylene-propylene block copolymer having a MFR of 30 g/10 min as the diluent polymer. The MFR of the former is four times the MFR of the latter, and thus the former and the latter have a large difference in the viscosity. In addition, the former has a lower viscosity than that of the latter, so that the former has a higher wetting property with respect to the long glass fiber filler. Therefore, when the resin material is heated and kneaded in the injection molding machine, the long glass fiber filler is coated and protected with homopolypropylene having a low viscosity and maintains this state, so that it is expected that the long glass fiber filler is effectively suppressed from breaking.

It seems that the bending modulus is improved because as the pentad isotactic index is increased, the ratio of the methyl groups in polypropylene having the same configuration along the polymer chain becomes higher, so that the polypropylene molecules are arranged as closely to each other as possible, and the crystallinity becomes high when solidified.

It seems that the Izod impact value is improved, because the weight-average fiber length becomes longer and the crystallinity of the polypropylene component becomes higher.

According to comparison of these examples, in Example 3 having a pentad isotactic index of 95% and Example 1 having a pentad isotactic index of 98%, an injection-molded article having a weight-average fiber length of 4 mm or more, a bending modulus of 5 GPa or more, and an Izod impact value of 30 KJ/m² or more can be obtained.

### Effects of the MFR of the Matrix Polymer

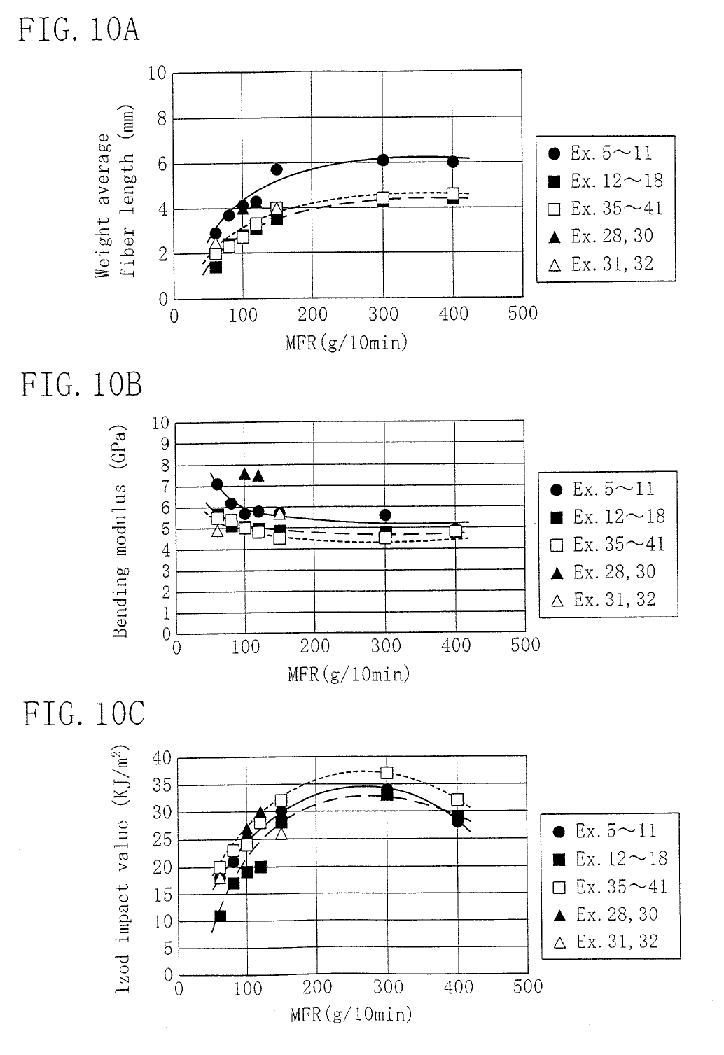

FIGS. 10A to 10C show the relationships between the MFR of the matrix polymer, and the weight-average fiber length, the bending modulus, and the Izod impact value, based on the test results of Examples 5 to 18 and Examples 35 to 41. FIGS. 10A to 10C also show the test results of Examples 28, 30, 31 and 32.

FIGS. 10A to 10C indicates that in all the examples of Examples 5 to 11 where homopolypropylene having a pentad isotactic index of 98% is used as the matrix polymer, Examples 12 to 18 where homopolypropylene having a pentad isotactic index of 94.5% is used as the matrix polymer, and Examples 35 to 41 where the ethylene-propylene block copolymer having a pentad isotactic index of 94.5% is used as the matrix polymer, the behaviors of the weight-average molecular weight, the bending modulus and the Izod impact value are unchanged regardless of the increase of the MFR (the decrease of the molecular weight).

More specifically, the weight-average fiber length becomes long with increasing the MFR until it reaches 150 g/10 min. This is because as the molecular weight of the matrix polymer becomes smaller, the melt viscosity thereof is reduced, so that breakage of the long glass fiber filler can be suppressed effectively in the injection molding process. Furthermore, although the weight-average fiber length is slightly improved when the MFR exceeds 150 g/10 min, the degree of improvement is small.

The bending modulus is reduced with increasing the MFR until it reaches 150 g/10 min. This is caused by the fact that the molecular weight of the matrix polymer becomes smaller. The bending modulus tends to stays substantially in the same level when the MFR exceeds 150 g/10 min.

The Izod impact value is improved with increasing the MFR until it reaches 300 g/10 min. This seems to be because breakage of the long glass fiber filler can be suppressed effectively. The Izod impact value is reduced when the MFR exceeds 300 g/10 min. This seems to be because the melt viscosity of the matrix polymer is too low, so that voids are generated in the molded article by containing air.

According to comparison of these examples, in Example 7 to 10 where homopolypropylene having a pentad isotactic index of 98% and a MFR of 100 to 300 g/10 min is used as the matrix polymer, an injection-molded article having a weight-average fiber length of 4 mm or more, a bending modulus of 5 GPa or more, and the Izod impact value of 25 KJ/m² or more can be obtained.

Example 28 is different from Example 30 in the MFR of polypropylene that is the matrix polymer. As shown in FIGS. 10A to 10C, the characteristics thereof tend to exhibit the same behaviors as above. Examples 28 and 30 are characterized in that the bending modulus is in higher level than those of the other examples.

Example 31 is different from Example 32 in the MFR of polypropylene that is the matrix polymer. As shown in FIGS. 10B, Example 32 having a MFR of 150 g/10 min has a higher bending modulus than that of the Example 31 having a MFR of 60 g/10 min. The tendency opposite to the above can be seen. However, as shown in FIGS. 10A and 10C, it does not seem that Examples 31 and 32 exhibit unique behaviors, as long as the results of the weight-average fiber length and the Izod impact value are concerned.

When Examples 5 to 11 where homopolypropylene having a pentad isotactic index of 98% is used as the matrix polymer is compared with Examples 12 to 18 where homopolypropylene having a pentad isotactic index of 94.5% is used as the matrix polymer, the former has higher levels in all of the weight-average fiber length, the bending modulus, and the Izod impact value. The reason for this may be the same as in the case where homopolypropylene is used as the matrix polymer, and the pentad isotactic index thereof is varied.

Comparison of Examples 11 to 18 where homopolypropylene is used as the matrix polymer and Examples 35 to 41 where ethylene-propylene block copolymer is used as the matrix polymer will be described later.

### Effects of Acid-denatured Polypropylene that is the Affinity Providing Component

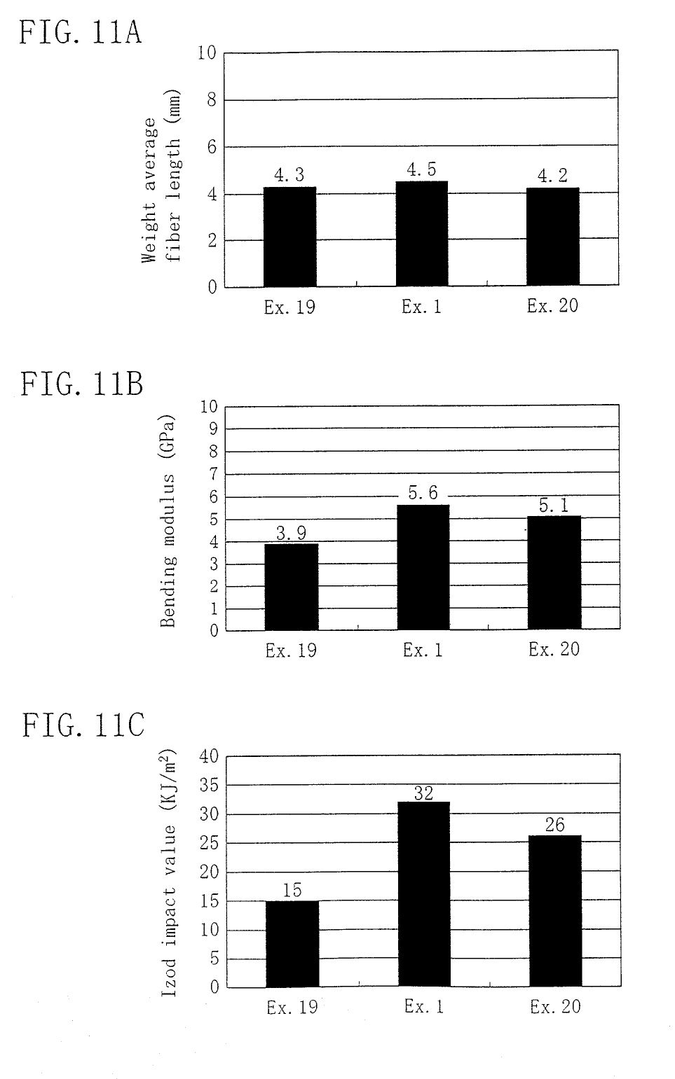

FIGS. 11A to 11B show a comparison of the weight-average fiber length, the bending modulus, and the Izod impact value of Examples 19, 1 and 20, based on the test results thereof. In Example 19, the affinity providing component between homopolypropylene as the matrix polymer and the long glass fiber filler is not contained. In Example 1, acrylic acid-denatured polypropylene is contained as the affinity providing component. In Example 20, maleic anhydride-denatured polypropylene is contained as the affinity providing component.

FIGS. 11A to 11B indicate that Example 19 that contains no affinity providing component exhibits the weight-average fiber length substantially equal to those of Examples 1 and 20 containing the affinity providing component, but exhibits significantly lower levels in the bending modulus and the Izod impact value. This seems to occur for the following reason. In Examples 1 and 20, the acid-denatured portion of the affinity providing component is chemically bonded to the coupling agent on the surface of the long glass fiber filler, and the polypropylene portion is diffused to homopolypropylene that is the matrix polymer, so that strong bonding is formed between the long glass fiber filler and the matrix polymer. On the other hand, in Example 19, such bonding is not formed, so that peeling occurs at the interface between the matrix polymer and the surface of the long glass fiber filler when bending deformation or impact is inflicted

According to comparison of these examples, in Example 1 and 20 containing the affinity providing component, an injection-molded article having a weight-average fiber length of 4 mm or more, a bending modulus of 5 GPa or more, and an Izod impact value of 25 KJ/m² or more can be obtained.

### Effects of the Content of the Acid-denatured Polypropylene that is the Affinity Providing Component

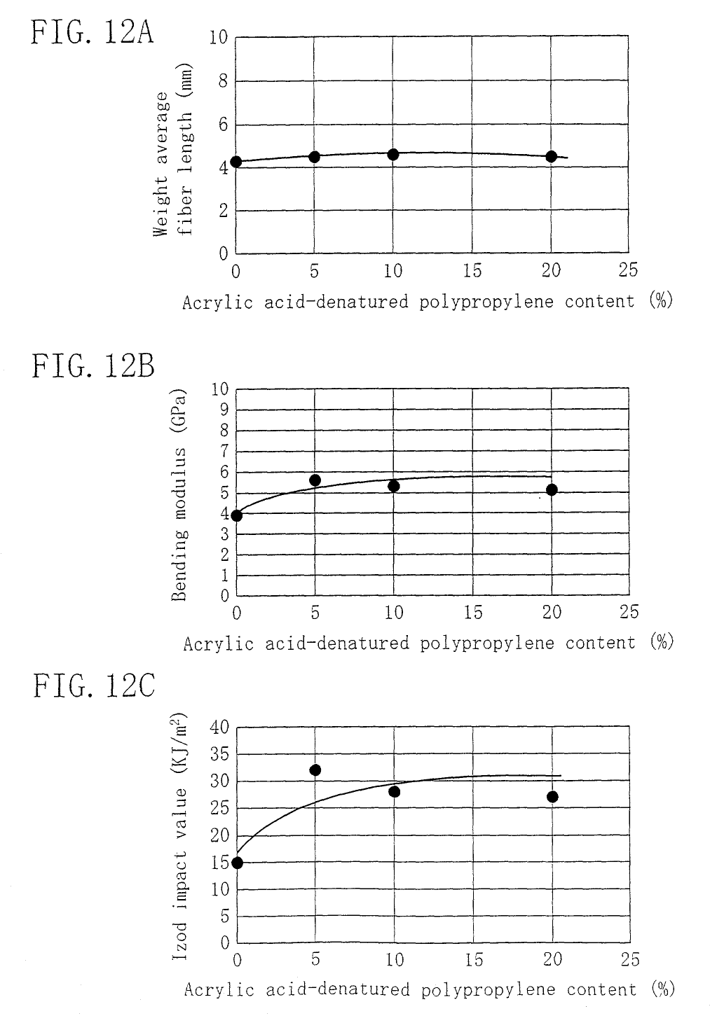

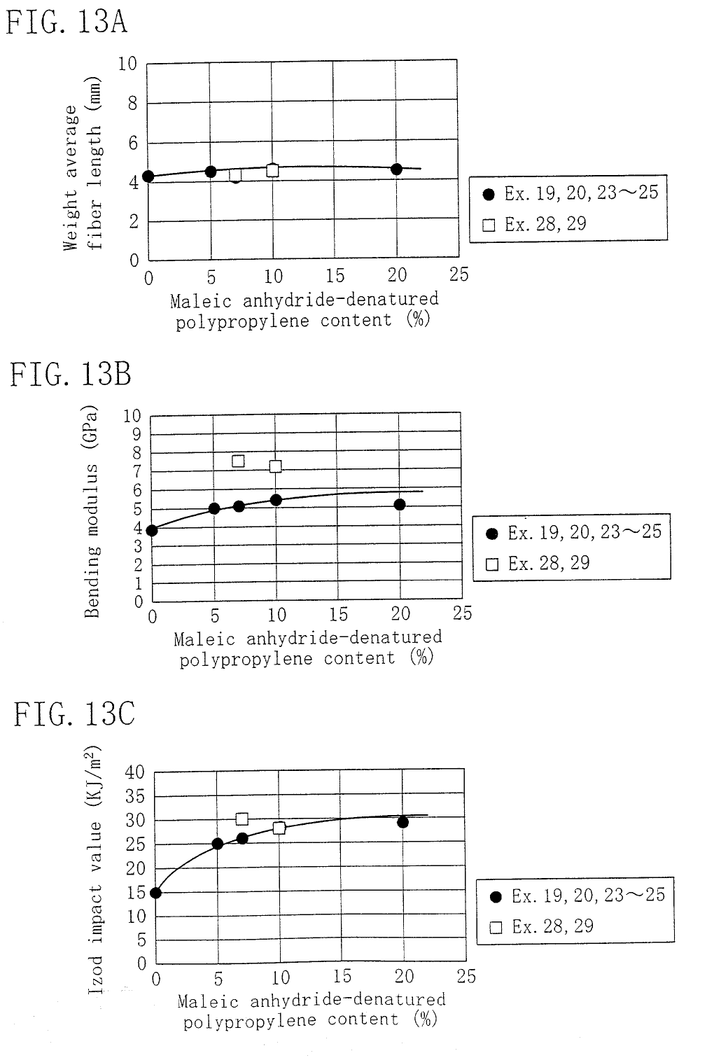

FIGS. 12A to 12C show the relationship between the content of acrylic acid-denatured polypropylene in the masterbatch, and the weight-average fiber length, the bending modulus and the Izod impact value, based on the test results of Examples 1, 19, 21 and 22. FIGS. 13A to 13C show the relationship between the content of maleic anhydride-denatured polypropylene in the masterbatch, and the weight-average fiber length, the bending modulus and the Izod impact value, based on the test results of Examples 19, 20 and 23 to 25. FIGS. 13A to 13C also show the test results of Examples 28 and 29.

According to FIGS. 12A and 13A, the weight-average fiber length is substantially in the level of a little more than 4 mm, regardless of the mixing amount of the acid-denatured polypropylene.

According to FIGS. 12B and 12C, the bending modulus and the Izod impact value are improved with increasing the content of acrylic acid-denatured polypropylene until the content reaches 5%, but not further improved with a content of more than 5%. Similarly, according to FIGS. 13B and 13C, in the case of maleic anhydride, the bending modulus and the Izod impact value are not further improved with a content of more than 10%.

Examples 28 and 29 both comprises homopolypropylene having a pentad isotactic index of 95% as the matrix polymer and are different only in the content of the maleic anhydride-denatured polypropylene as the affinity providing component. As shown in FIGS. 13A to 13C, the same tendency as above is exhibited. More specifically, Examples 28 and 29 are substantially in the same level as those of Examples 20 and 24 comprising the same content of maleic anhydride-denatured polypropylene with respect to the weight-average fiber length and the Izod impact value. With respect to the bending modulus, Examples 28 and 29 are in higher levels than those of Examples 20 and 24, but are substantially in the same level regardless of the content of maleic anhydride-denatured polypropylene.

### Effects of Using an Ethylene-propylene Block Copolymer as the Matrix Polymer or Using an Ethylene-propylene Block Copolymer as the Diluent Polymer

In FIGS. 10A to 10C, when Examples 12 to 18 where homopolypropylene having a pentad isotactic index of 94.5% is used as the matrix polymer are compared with Examples 35 to 41 where ethylene-propylene block copolymer comprising a polypropylene component having a pentad isotactic index of 94.5% is used as the matrix polymer, the former and the latter exhibit close values in the weight-average molecular weight and the bending modulus with respect to the corresponding MFR. However, regarding the Izod impact value, the latter has a 3 to 9 kJ/m² higher value, and this level is substantially equal to or more than those of Examples 5 to 11 where homopolypropylene having a pentad isotactic index of 98% is used as the matrix polymer. The reason for this seems as follows. In Examples 35 to 41, the ethylene-propylene block copolymer that is the matrix polymer has an islands-sea structure where the domains of the polyethylene component are formed in the polypropylene component, so that an inflicted impact is energy-absorbed in the boundary portion of the polypropylene component and the polyethylene component.

Next, the case where homopolypropylene is used as the matrix polymer of the masterbatch, and an ethylene-propylene block copolymer is used as the diluent polymer will be examined.

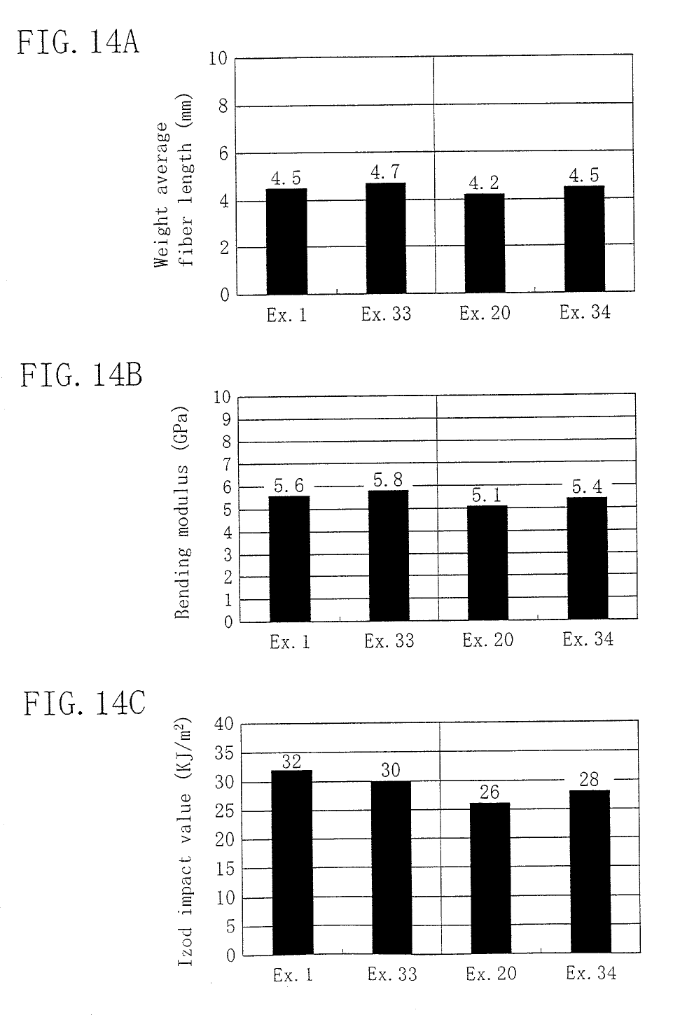

FIGS. 14A to 14C show a comparison of the weight-average fiber length, the bending modulus, and the Izod impact value between Examples 1 and 33, and 20 and 34, based on the test results thereof. Herein, Examples 1 and 33 are different in the type of the diluent polymer mixed with the masterbatch. In Example 1, ethylene-propylene block copolymer is used, and in Example 33, homopolypropylene is used. The difference between Examples 20 and 34 is the same as above.

According to FIGS. 14A to 14C, regarding the weight-average fiber length and the bending modulus, Example 1 where ethylene-propylene block copolymer is used as the diluent polymer exhibits a slightly higher value than that of Example 33 where homopolypropylene is used as the diluent polymer. This holds true for the comparison between Examples 20 and 34. Regarding the Izod impact value, although Example 1 has a slightly higher value than that of Example 33, Example 20 has a lower than that of Example 34, and no improvement of the ethylene-propylene block copolymer in the impact resistance as shown in FIGS. 10A to 10C is observed. This may be due to the difference in the pentad isotactic index of the polypropylene component of the diluent polymer.

### Effects of the Pentad Isotactic of the Polypropylene Component of the Ethylene-propylene Block Copolymer as the Diluent Polymer

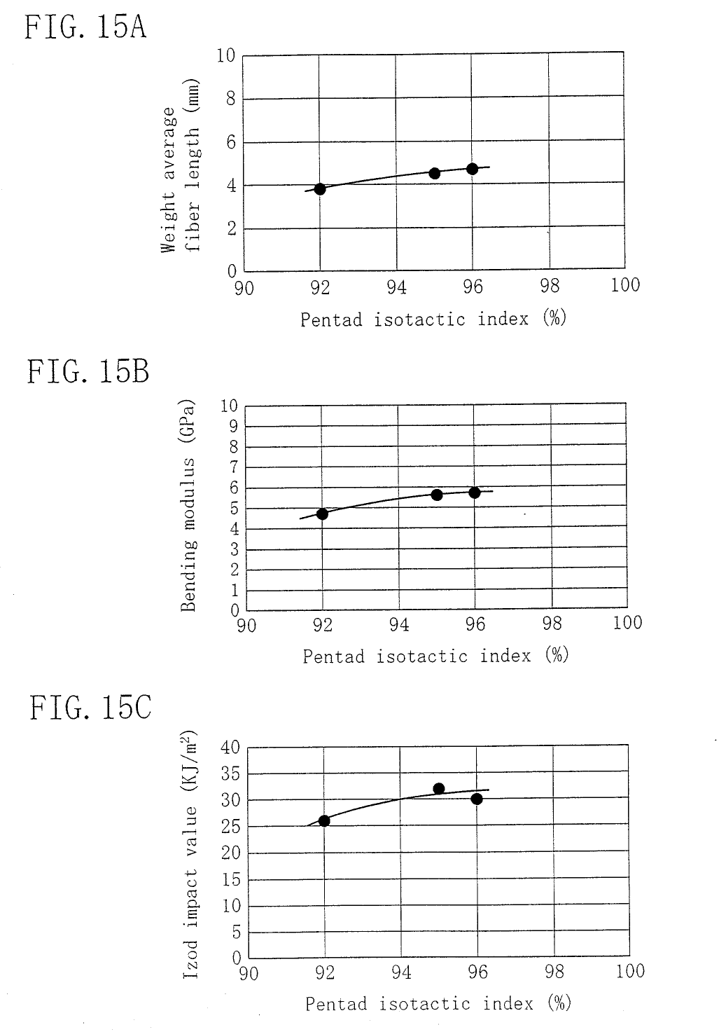

FIGS. 15A to 15C show the relationships between the pentad isotactic index of the polypropylene component of ethylene-propylene copolymer as the diluent polymer, and the weight-average fiber length, the bending modulus, and the Izod impact value of Examples 1, 26 and 27, based on the test results thereof.

According to FIGS. 15A to 15C, all of the weight-average fiber length, the bending modulus, and the Izod impact value tend to be improved with increasing the pentad isotactic index of the polypropylene component of the ethylene-propylene copolymer that is the diluent polymer. More specifically, it was confirmed that also in the case the masterbatch is diluted with the diluent polymer comprising the polypropylene component, the pentad isotactic index thereof significantly can affect the characteristics of a molded article.

The reason why the characteristics are improved with increasing the pentad isotactic index seems to be the same as in the case where homopolypropylene is used as the matrix polymer and the pentad isotactic index thereof is varied.

According to comparison of these examples, in Example 1 where the pentad isotactic index is 95% and Example 26 where the pentad isotactic index is 96%, an injection-molded article having a weight-average fiber length of 4 mm or more, a bending modulus of 5 GPa or more, and an Izod impact value of 30 kJ/m² or more can be obtained.

In Example 42, the content of the acid-denatured polypropylene that is an affinity providing component is not more than 2.0 mass percent. This is smaller than those of other examples except Example 19. However, in Example 42, the weight-average fiber length is 4.56 mm, the bending modulus is 5.6 GPa, and the Izod impact value is 38 kJ/m², all of which are in high level. This seems to be because in Example 42, the content of the acid-denatured polypropylene that is an affinity providing component is small, and the ratio of the matrix polymer and the diluent polymer is large, so that the strength of the resin body is increased.

Furthermore, FIGS. 9A to 9C and 10A to 10C show that although the bending modulus and the Izod impact value are improved with increasing the content of the acid-denatured polypropylene until a certain amount, there is no improvement when the content exceeds the certain value. Judging from the test results of Example 42, in the embodiment of Example 42, it seems that the certain value is about 2.0% with respect to the total mass, and such a content of the acid-denatured polypropylene can ensure a sufficient affinity between the long glass fiber filler and the matrix polymer.

### Experiment 2

The relationship between the mass percentage of the long glass fiber filler contained in the long glass fiber filler reinforced polypropylene resin material and the bending properties and the Izod impact value of the molded article therefrom was examined.

### Test Evaluation Samples

Glass fiber bundles were immersed in a melt of homopolypropylene having a pentad isotactic index of 98% and a MFR of 120 g/10 min (weight-average molecular weight Mw=101200) and acrylic acid-denatured polypropylene. Thereafter, the glass fibers impregnated with the melt were solidified and then cut to an average length of 10 mm in the longitudinal direction to prepare a masterbatch in pellet form. This masterbatch was constituted by 25 mass percent of the homopolypropylene, 5 mass percent of the acrylic acid-denatured polypropylene and 70 mass percent of the long glass fiber filler.

The masterbatch was diluted, as appropriate, with homopolypropylene in pellet form comprising a polypropylene component having a pentad isotactic index of 96%, and long glass fiber filler reinforced materials comprising the long glass fiber filler in a content of 10, 20, 30, 40 and 50 mass percent with respect to the total mass were prepared. As a material for comparison, a pellet constituted only by the homopolypropylene contained in the masterbatch was prepared.

### Test Evaluation Method

A plate-like test specimen was injection-molded with each of the prepared resin materials and the material for comparison. Then, bending test was performed with these test specimens according to JIS K7171 (ASTM D790). Then, the bending modulus was obtained from the obtained test chart.

Furthermore, the Izod impact value of each of the resin materials and the material for comparison was measured according to JIS K7110 (ASTM D256).

### Test Evaluation Results

### Bending Modulus

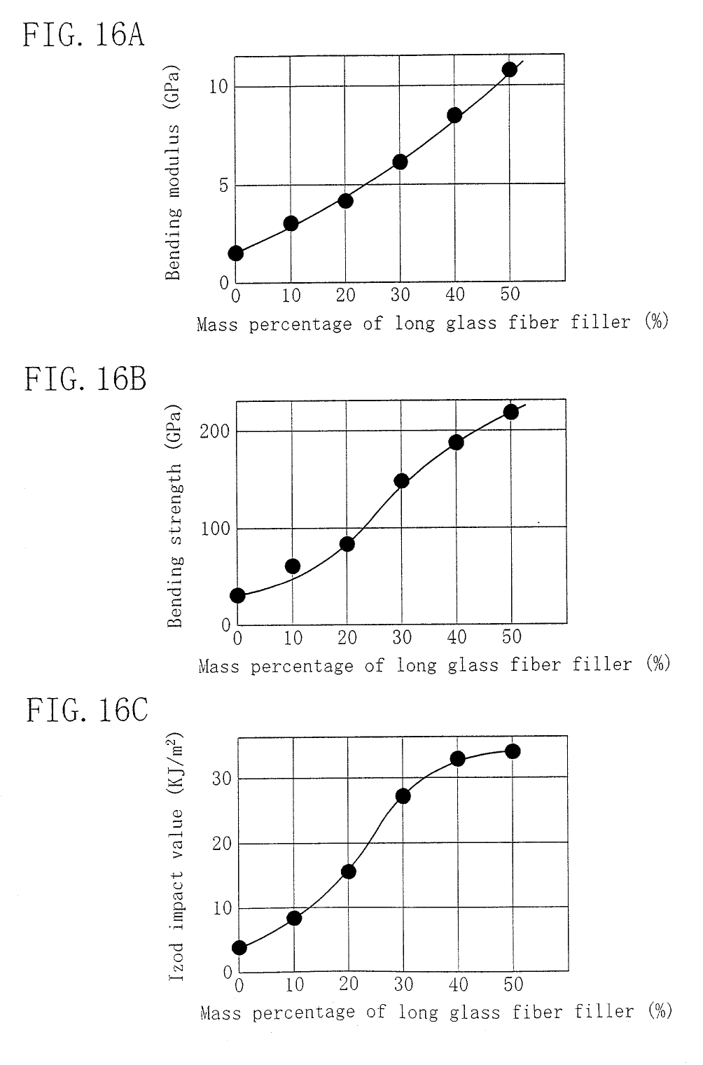

FIG. 16A shows the relationship between the mass percentage of the long glass fiber filler and the bending modulus. As seen from FIG. 16A, as the content of the long glass fiber filler is increased, the bending modulus is increased, substantially in proportion thereto. These results support that the bending modulus of the article molded with the long glass fiber filler reinforced polypropylene resin depends on the content of the long glass fiber filler. More specifically, a bending modulus of 5 GPa or more is achieved when the content of the long glass fiber filler is 30% or more.

### Bending Strength

FIG. 16B shows the relationship between the mass percentage of the long glass fiber filler and the bending strength. As seen from FIG. 16B, as the content of the long glass fiber filler is increased, the bending strength is increased. This corresponds to the results of the bending modulus.

### Izod Impact Value

FIG. 16C shows the relationship between the mass percentage of the long glass fiber filler and the Izod impact value. As seen from FIG. 16C, as the content of the long glass fiber filler is increased, the Izod impact value is increased. What should be noted is that when the mass percentage of the long glass fiber filler is 30% or 40%, the Izod impact value is in the level of 25 KJ/m² or more, which cannot be attained by a conventional molded article having the same mass percentage of the long glass fiber filler.

As for the data of Experiments 1 and 2, the Izod impact values were obtained in a test with test specimens obtained by providing a notch portion in a rod-shape body cut out from an actual molded article in a post processing, and the bending modulus was measured with test specimens cut out from an actual molded article. Therefore, higher Izod impact values and higher bending modulus are expected with a molded article (test specimen) itself that is not cut out from an actual molded article by the orientation of the long glass filer filler.

### Experiment 3

Test evaluation was performed for comparison of the flexural fatigue properties of the long glass fiber filler reinforced polypropylene resin material and the long glass fiber filler reinforced polyamide resin material.

### Test Evaluation Samples

A masterbatch in pellet form having an average length of 10 mm constituted by 47 mass percent of homopolypropylene having a pentad isotactic index of 95% and a MFR of 120 g/10 min (weight-average molecular weight Mw=101200), 5 mass percent of acrylic acid-denatured polypropylene and 48 mass percent of the long glass fiber filler was prepared. Then, 20 parts by mass of an ethylene-propylene block copolymer in pellet form comprising a polypropylene component having a pentad isotactic index of 95% and having a MFR of 30 g/10 min as the diluent polymer was mixed with 100 parts by mass of the masterbatch so that the mass percentage of the long glass fiber filler with respect to the total mass was 40%. Thus, a long glass fiber filler reinforced polypropylene resin material, that is, the resin material of Example 2 used in Experiment 1, was prepared.

Furthermore, a long glass fiber filler reinforced polyamide resin material in the same form of pellet as that of the masterbatch of the above-described resin material containing 30 mass percent of the long glass fiber filler was prepared.

### Test Evaluation Method

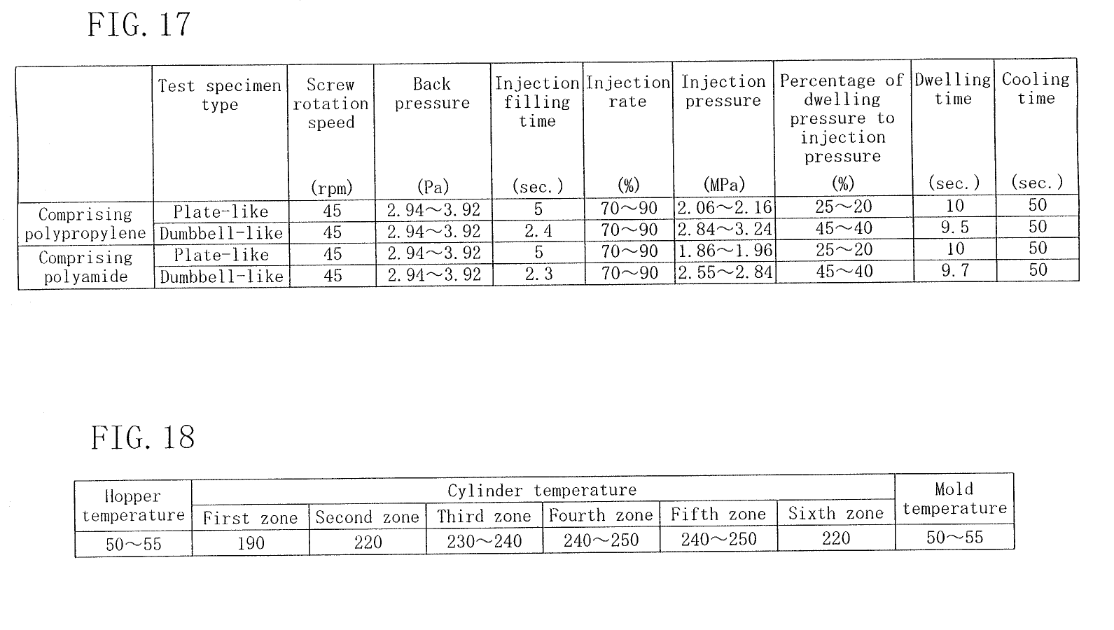

The prepared resin materials were fed into the injection molding machine to be molded into several plate-like test specimens and several dumbbell-like test specimens by injection molding. In this case, the plate-like test specimens were injection-molded with the resin material comprising polypropylene of Example 2 under the following conditions: the screw rotation speed was 45 rpm; the back pressure was 2.94×10⁵ to 3.92×10⁵ Pa; the injection rate was 70 to 90%; the injection pressure was 2.06 to 2.16 MPa; the pressure for dwelling was 25 to 20% of the injection pressure; the injection speed (injection filling time) was 5.0 seconds; the period of time for dwelling was 10 seconds; and the cooling time was 50 seconds (see FIG. 17). The temperature of the hopper of the injection molding machine was set at 55° C., and the temperature of the mold was set at 50 to 55° C. The cylinder was divided into 6 sections, and the temperatures of the sections were set at 190° C., 220° C., 230 to 240° C., 240 to 250° C., 240° C. to 250° C. and 220° C. in this order from the hopper side to the mold side (see FIG. 18). The dumbbell-like test specimens were injection-molded with the resin material comprising polypropylene of Example 2 under the following conditions: the screw rotation speed was 45 rpm; the back pressure was 2.94×10⁵ to 3.92×10⁵ Pa; the injection rate was 70 to 90%; the injection pressure was 2.84 to 3.24 MPa; the pressure for dwelling was 45 to 40% of the injection pressure; the injection speed (injection filling time) was 2.4 seconds; the period of time for dwelling was 9.6 seconds; and the cooling time was 50 seconds (see FIG. 17). The temperature of the hopper of the injection molding machine was the same as that for the plate-like test specimens (see FIG. 18). The weight-average fiber length of all of the plate-like test specimens and the dumbbell-like test specimens was 4 mm or more.

The injection molding conditions of the plate-like test specimens formed of the resin material comprising polyamide were the same as the molding conditions for the plate-like test specimens of Example 2, except that the injection pressure was 1.86 to 1.96 MPa (see FIGS. 17 and 18). The injection molding conditions of the dumbbell-like test specimens formed of the resin material comprising polyamide were the same as the molding conditions for the dumbbell-like test specimens of Example 2, except that the injection pressure was 2.55 to 2.84 MPa, the injection speed (injection filling time) was 2.3 seconds and the dwelling time was 9.7 seconds (see FIGS. 17 and 18). The weight-average fiber length of all of the plate-like test specimens and the dumbbell-like test specimens was 1 mm or less.

The test for flexural fatigue of plastics by constant-amplitude-of force was conducted with these dumbbell-like test specimens molded with the resin material comprising polypropylene or polyamide, according to ASTM D671 (JIS K7118 and 7119). The test for flexural fatigue was performed at 100° C. and 120° C. For stress, 4 levels were set in the range from 20 to 5 MPa for each test temperature of each resin material.

Then, the number of times of bending until breakage of each test specimen for each set stress was recorded for each resin material.

### Test Evaluation Results

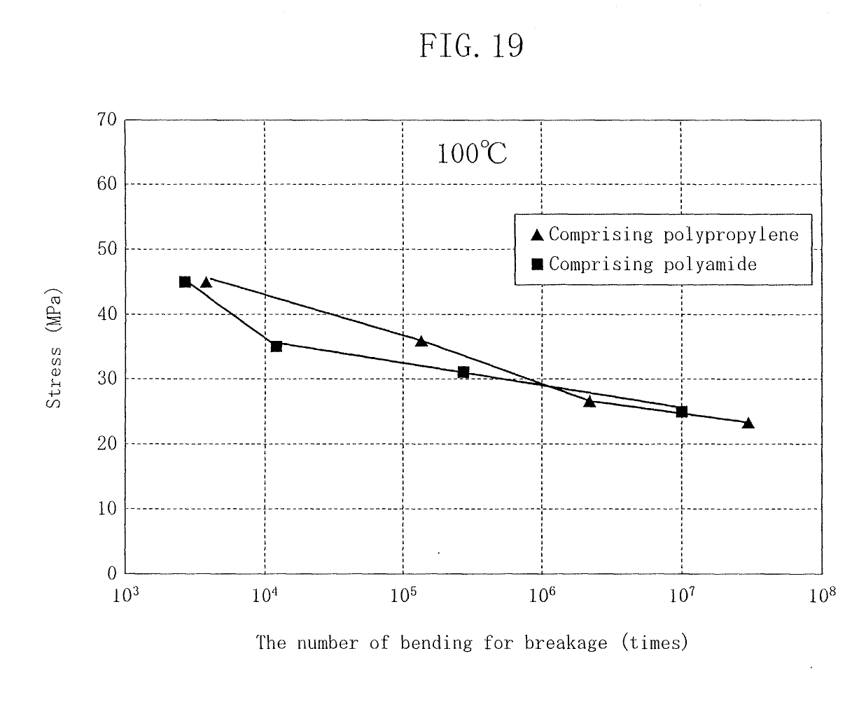

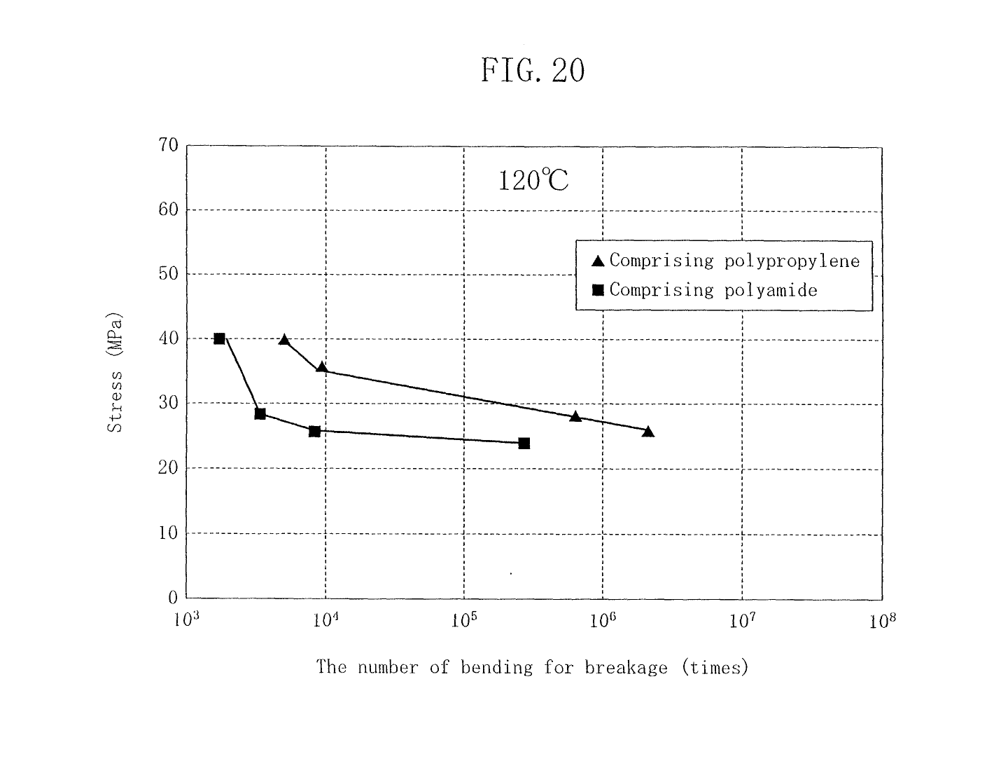

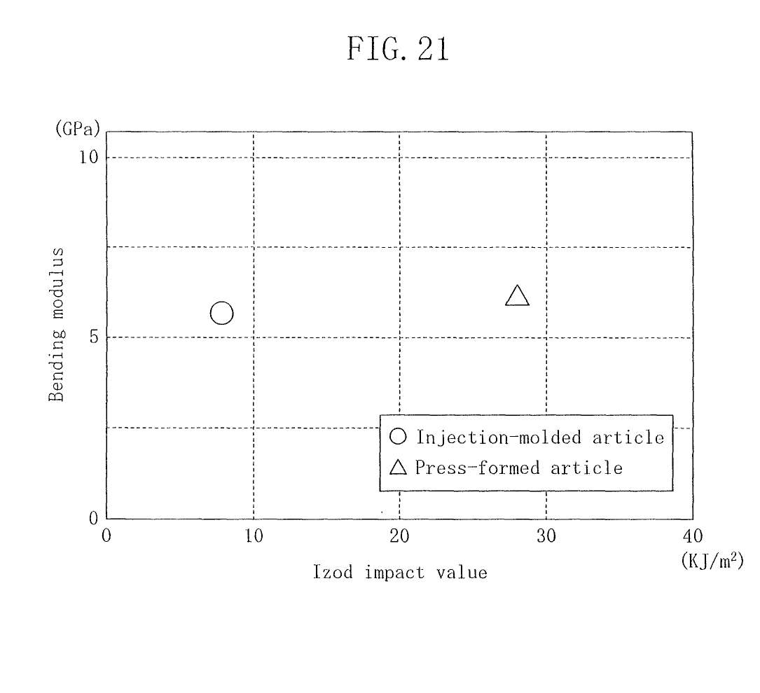

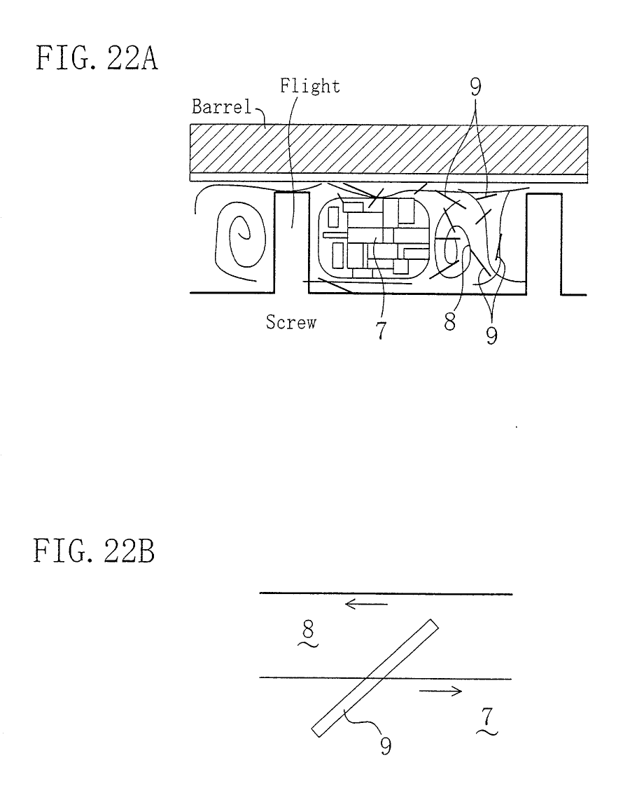

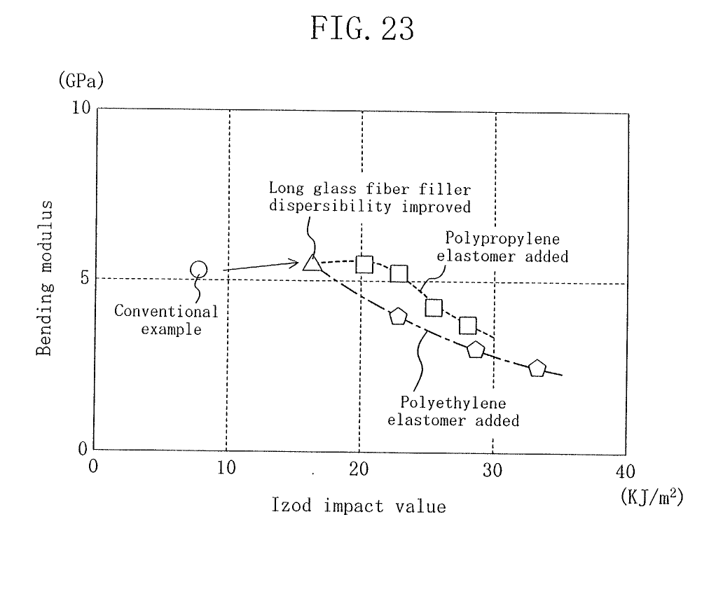

FIGS. 19 and 20 show the test results at 100° C. and 120° C., respectively. According to these graphs, at the temperature of 100° C., the injection-molded articles molded with the resin material comprising polypropylene of Example 2 have substantially the same level of flexural fatigue resistance as that of the resin material comprising polyamide. At the temperature of 120° C., the injection-molded articles molded with the resin material comprising polypropylene have higher flexural fatigue resistance as that of the resin material comprising polyamide. This seems to have occurred for the following reasons. Since the weight-average fiber length of the long glass fiber filler contained in the injection-molded article with the resin material comprising polypropylene of Example 2 is 4 mm or more (see FIG. 8), the reinforcing effect can be maintained at high test temperatures. Therefore, a degree of deterioration of the flexural fatigue resistance is small. On the other hand, the weight-average fiber length of the long glass fiber filler contained in the injection-molded article with the resin material comprising polyamide is 1 mm or less, the reinforcing effect is significantly reduced at high test temperatures. Therefore, a degree of deterioration of the flexural fatigue resistance is large.

Since the temperature of the site where a shroud module of an automobile is increased to about 100° C., conventionally, the long glass fiber filler reinforced polyamide resin material has been used as the material for the shroud module for the following reason. The fatigue resistance of the injection-molded article at high temperatures is better than that of the molded article with the long glass fiber filler reinforced polypropylene resin material, although there are problems in salt damage or corrosivity and in that the deformation occurs when water is absorbed so that the precision is poor. However, in the long glass fiber filler reinforced polypropylene resin material of the present invention, the weight-average fiber length of the long glass fiber filler contained in the injection-molded article therewith is 4 mm or more, and therefore the fatigue resistance at high temperatures is better than that of the molded article with the long glass fiber filler reinforced polyamide resin material. Moreover, the present invention is free from the demerits of salt damage or the like. Thus, the present invention can be used as the resin material for the shroud module of an automobile.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A long glass fiber filler reinforced resin material for molding comprising:
a matrix polymer comprising a polypropylene component having a pentad isotactic index of at least 95%, and having a melt flow rate (JIS K7210, a temperature of 230° C.; and a load of 21.18N) of 100 to 300 g/10 min;
a long glass fiber filler in a content of 30 to 50 mass percent with respect to a total mass;
an affinity providing component for providing affinity between the matrix polymer and the long glass fiber filler,
wherein at least the matrix polymer and the long glass fiber filler form a composite.

2. The long glass fiber filler reinforced resin material for molding of claim 1, wherein the composite has a form of a 10 to 12 mm rod-shaped pellet, and the long glass fiber filler is aligned in a longitudinal direction of the rod-shaped pellet.

3. The long glass fiber filler reinforced resin material for molding of claim 1, wherein
a surface of the long glass fiber filler is treated with a coupling agent,
the affinity providing component is acid-denatured polypropylene having a functional group that reacts chemically with the coupling agent with which the surface of the long glass fiber filler is treated.

4. The long glass fiber filler reinforced resin material for molding of claim 3, wherein the acid-denatured polypropylene comprises at least one selected from the group consisting of maleic anhydride-denatured polypropylene and acrylic acid-denatured polypropylene as a constituent.

5. The long glass fiber filler reinforced resin material for molding of claim 1, wherein the matrix polymer is homopolypropylene.

6. The long glass fiber filler reinforced resin material for molding of claim 5, wherein an ethylene-propylene block copolymer comprising a polypropylene component having a pentad isotactic index of at least 95% is mixed therewith.

7. The long glass fiber filler reinforced resin material for molding of claim 6, which is for use in injection molding.

8. An injection-molded article produced by injection-molding the long glass fiber filler reinforced resin material for molding of claim 7,
wherein a weight-average fiber length of the contained glass fiber filler is at least 4 mm, a bending modulus thereof is at least 5 GPa, and an Izod impact value thereof is at least 25 KJ/m².

9. The injection-molded article of claim 8, which is any one of a shroud module, a door module, a liftgate module, a bumper module, a step member, and a structure instrument panel member for vehicles.

10. A long glass fiber filler reinforced resin material for molding comprising:
a masterbatch comprising a matrix polymer comprising a polypropylene component having a pentad isotactic index of at least 95%; a long glass fiber filler in a content of 30 to 50 mass percent with respect to a total mass; and an affinity providing component for providing affinity between the matrix polymer and the long glass fiber filler, wherein at least the matrix polymer and the long glass fiber filler form a composite; and
a diluent polymer comprising a polypropylene component having a pentad isotactic index of at least 95%,
wherein a melt flow rate of the matrix polymer of the masterbatch is larger than twice a melt flow rate of the diluent polymer.

11. The long glass fiber filler reinforced resin material for molding of claim 10, wherein a melt flow rate (JIS K7210, a temperature of 230° C.; and a load of 21.18N) of the matrix polymer of the masterbatch is 100 to 300 g/10 min.

12. The long glass fiber filler reinforced resin material for molding of claim 11, which is for use in injection molding.

13. An injection-molded article produced by injection-molding the long glass fiber filler reinforced resin material for molding of claim 12,
wherein a weight-average fiber length of the contained glass fiber filler is at least 4 mm, a bending modulus thereof is at least 5 GPa, and an Izod impact value thereof is at least 25 KJ/m².

14. The injection-molded article of claim 13, which is any one of a shroud module, a door module, a liftgate module, a bumper module, a step member, and a structure instrument panel member for vehicles.

15. An injection-molded article produced by injection-molding a long glass fiber filler reinforced resin material for molding comprising a matrix polymer containing a polypropylene component, and a long glass fiber filler contained in the matrix polymer in a content of 30 to 50 mass percent with respect to a total mass,
wherein a weight-average fiber length of the contained glass fiber filler is at least 4 mm, a bending modulus thereof is at least 5 GPa, and an Izod impact value thereof is at least 25 KJ/m².

16. The injection-molded article of claim 15, which is any one of a shroud module, a door module, a liftgate module, a bumper module, and a step member for vehicles.

17. A method for molding a long glass fiber filler reinforced resin material comprising:
heating for melting a resin component of the long glass fiber filler reinforced resin material for molding of claim 7;
kneading the melt under shear flow; and
molding the kneaded melt into a predetermined shape.

18. A method for molding a long glass fiber filler reinforced-resin material comprising:
heating for melting a resin component of the long glass fiber filler reinforced resin material for molding of claim 12;
kneading the melt under shear flow; and
molding the kneaded melt into a predetermined shape.

19. A method for molding an injection-molded article using an injection molding machine including resin heating means, a screw and a mold, comprising:
feeding a long glass fiber filler reinforced resin material for molding into the injection molding machine, the long glass fiber filler reinforced resin material comprising a composite of homopolypropylene having a pentad isotactic index of at least 95% and a melt flow rate (JIS K7210, a temperature of 230° C.; and a load of 21.18N) of 100 to 300 g/10 min, and a long glass fiber filler, wherein the composite has a form of a 10 to 12 mm rod-shaped pellet, and the long glass fiber filler is aligned in a longitudinal direction of the rod-shaped pellet;
heating the resin material fed into the injection molding machine by the resin heating means, thereby melting a resin component thereof while kneading the resin material by rotating the screw at a rotation speed of 20 to 40 rpm; and
injecting the heated and kneaded resin material into the mold at an injection filling time of 2.5 to 7.0 seconds, thereby producing an injection-molded article comprising the long glass-fiber filler in a content of 30 to 50 mass percent with respect to the total mass, and having a weight-average fiber length of at least 4 mm, a bending modulus of at least 5 GPa, and an Izod impact value of at least 25 KJ/m².

20. The method of claim 19, wherein the injection-molded article is a shroud module for vehicles.

21. A method for molding an injection-molded article for a shroud module for vehicles, using an injection molding machine including resin heating means, a screw and a mold, comprising:
feeding a long glass fiber filler reinforced resin material for molding into the injection molding machine, the long glass fiber filler reinforced resin material comprising a composite of homopolypropylene having a pentad isotactic index of at least 95% and a melt flow rate (JIS K7210, a temperature of 230° C.; and a load of 21.18N) of 100 to 300 g/10 min, and a long glass fiber filler, wherein the composite has a form of a 10 to 12 mm rod-shaped pellet, and the long glass fiber filler is aligned in a longitudinal direction of the rod-shaped pellet;
heating the resin material fed into the injection molding machine by the resin heating means, thereby melting a resin component thereof while kneading the resin material by rotating the screw; and
injecting the heated and kneaded resin material into the mold, thereby producing a shroud module for vehicles comprising the long glass fiber filler in a content of 30 to 50 mass percent with respect to the total mass, and having a weight-average fiber length of at least 4 mm, a bending modulus of at least 5 GPa, and an Izod impact value of at least 25 KJ/m².

22. The method for molding an injection-molded article of claim 21,
wherein the long glass fiber filler reinforced resin material for molding comprises an ethylene-propylene block copolymer comprising a polypropylene component having a pentad isotactic index of at least 95%.

23. A method for molding an injection-molded article using an injection molding machine including resin heating means, a screw and a mold, comprising:
preparing a long glass fiber filler reinforced resin material comprising a matrix polymer comprising a polypropylene component having a pentad isotactic index of at least 95% and having a melt flow rate (JIS K7210, a temperature of 230° C.; and a load of 21.18N) of 100 to 300 g/10 min; a long glass fiber filler in a content of 30 to 50 mass percent of with respect with respect to a total mass; an affinity providing component for providing affinity between the matrix polymer and the long glass fiber filler, wherein at least the matrix polymer and the long glass fiber filler form-a composite,
feeding the resin material into the injection molding machine;
heating the resin material fed into the injection molding machine by the resin heating means, thereby melting a resin component thereof while kneading the resin material by rotating the screw at a rotation speed of 20 to 60 rpm; and
injecting the heated and kneaded resin material into the mold at a back pressure of 2.94×10⁵ to 3.92×10⁵ Pa, an injection filling time of 2.0 to 7.0 seconds, an injection rate of 70 to 90% and an injection pressure of 1.86 to 3.24 MPa;
keeping the resin material injected into the mold under dwelling at a pressure of 20 to 45% of the injection pressure for 9 to 20 seconds; and
opening the mold to remove an injection-molded article.
